(19) United States
(12) Patent Application Publication
(10) Pub. No.: US 2025/0069145 A1
(43) Pub. Date: Feb. 27, 2025

(54) SYSTEM AND METHOD FOR MANAGEMENT OF PHYSICAL ASSETS

(71) Applicant: CURIE TECHNOLOGIES, INC., New York, NY (US)

(72) Inventors: Anne Marie PELLERIN, Saint Germain en Laye (FR); Florian SCHOLOCHOW, Innsbruck (AT); Sonja FIEGL, Innsbruck (AT); Markus BÜRGLER, Navis (AT); Matthias BENDLER, Innsbruck (AT); Ivan LEUZZI, Innsbruck (AT)

(21) Appl. No.: 18/941,484

(22) Filed: Nov. 8, 2024

Related U.S. Application Data
(63) Continuation of application No. PCT/US2024/031585, filed on May 30, 2024.
(60) Provisional application No. 63/505,277, filed on May 31, 2023.

(51) Int. Cl. G06Q 40/06

(52) U.S. Cl. CPC G06Q 40/06

(57) ABSTRACT

An asset management system or platform which enables stakeholders to monitor, service, and maintain physical assets. The asset management system is comprised of a platform existing on a computer system and a plurality of separate and discrete sub-data structures, there being one sub-data structure for each stakeholder. The data for an asset is distributed among multiple of the sub-data structures. Using the platform, a user can view all necessary information related to an asset even though the particular user does not have direct access to the data. Rather, the platform pulls the relevant data from relevant sub-data structures and provides the user to view and edit the information based on permissions.

### CROSS-REFERENCE TO RELATED APPLICATIONS

This application claims is a continuation of International App. No. PCT/US2024/031585 filed May 30, 2024 which claims priority to U.S. App. No. 63/505,277 filed May 31, 2023, entitled “System And Method For Asset Management”, both of said applications being incorporated herein by reference.

### STATEMENT REGARDING FEDERALLY SPONSORED RESEARCH OR DEVELOPMENT

Not Applicable.

### BACKGROUND

Disclosed is an asset management system or platform, and associated methods, that, at one level facilitates onboarding of physical assets, status checks, and subsequent maintenance, testing/calibration, and servicing of the assets by stakeholders, i.e., owners, operators, and maintainers (service and maintenance entities). Such physical assets can include equipment or assets related to security and safety which require certification (such as airport security screening equipment) or more general equipment, such as security cameras. Although described for use with security in transportation-related facilities (such as airports), the disclosed methods and asset management system have application in other facilities, such as federal facilities, laboratories, nuclear facilities, hospitals, etc., which use equipment requiring certification, robust testing, calibration, and maintenance. On another level, the asset management system and associated methods provide a common platform to connect the asset owner (or buyer), operator (or user), maintainer (service and maintenance entities), and the manufacturer. Additionally, the asset management system or platform will allow aggregating of data around individual assets to better drive analytics over time.

Security equipment and their possible configurations which are used, for example, for screening of passengers, baggage, and freight, must be certified for use in different jurisdictions. Further, security equipment and their possible configurations are subject to differing certification requirements by different jurisdictions. Thus, equipment certified in one jurisdiction (i.e., US) may not be certified in another jurisdiction (i.e., Europe). Databases exist that list what equipment and which configurations have been certified for use in what jurisdictions, but the various databases are not harmonized regarding terms. Further, definitions, and especially nomenclature, get updated in different time intervals, and thus existing databases do not always include the updated requirements which makes it extremely time intensive to find out the updates and new requirements for the operation. The databases are therefore not easy to use. Further, these databases can be difficult to find. Additionally, equipment may be decertified by a regulating body if problems are detected (e.g., through regular testing). In that event, owners and/or operating entities may be unaware of the decertification. Therefore, in general, it is difficult for a stakeholder to determine if specific equipment has been certified for use in the relevant jurisdiction and to keep up to date with constantly evolving requirements and related upgrades.

The security equipment (x-ray machines, chemical detectors, body scanners, luggage scanners, cargo scanners, etc.) must be tested, calibrated, and serviced on a set schedule to remain in compliance. Equipment may need to be tested and calibrated, for example, daily or weekly, and serviced or maintained, for example, every three months. Further, there are often multiple layers of required maintenance. For example, the OEM/builder may recommend certain maintenance to ensure the equipment remains operational; the service and maintenance provider may be required to do certain maintenance tasks based on their contract with the equipment owner; and national regulation may require certain maintenance tasks. These varying tasks can be difficult to keep track of. Additionally, if equipment is serviced between scheduled services (i.e., if the equipment breaks down), the servicing schedule is typically adjusted. Thus, with the example of a 3-month servicing cycle, if the equipment is serviced between normal scheduled servicing, the service schedule is adjusted such that the next servicing occurs 3 months from the unscheduled servicing. However, the technician may not be aware that the service schedule has been adjusted, and may service the equipment on the original servicing schedule. Thus, the technician may service a machine that does not need to be serviced at that time. This will use up time which the technician could have used to perform necessary servicing of other equipment within the facility (such as an airport).

Currently, the systems for testing, servicing, and maintaining security equipment are very fragmented, with the various stakeholders operating in their own silos. There can be four or five separate entities involved with the security equipment: the manufacturer, the distributor, the owner (airport, airline, leasing company, etc.), the operating entity (which is sometimes, but not always, the owner), and the servicing entity (which is sometimes, but not always, the owner). There is no current way for these stakeholders to easily share data, and thus the data become siloed without any way to share the data. Siloed data exists even within a single user group. As an example, U.S. Customs and Border Protection operates 13 different asset management platforms that do not talk to each other. One platform is used by procurement, one by field operations, one by compliance, etc. Further, the various entities are often not willing to share information regarding their assets because, to do so, they typically need to share all of their information, and, they are not willing to give another party access to their systems. Currently, there is no system that is acceptable to the various stakeholders for sharing information related to their assets.

Equipment is often sold to the owner through a distributor. Even if sold directly from the manufacturer, in most instances, there is no avenue for communication between owner and manufacturer. This makes it difficult for the manufacturer to learn when there might be issues with the equipment and for the manufacturer to distribute updates/patches to the owners as may be required, for example, to deal with security issues. Further, because there is typically no avenue for direct communication between the manufacturer and the owner/operator, it is difficult for the manufacturer to aggregate information regarding specific models of equipment (such as operating issues with the equipment), and thus, the manufacturer may not learn of an endemic issue relating to the model quickly—which can thereby delay the rollout of an upgrade or fix to the affected equipment.

Additionally, equipment software is periodically updated. For example, a manufacturer may release a software update for a specific model of equipment. Currently, it is difficult for the manufacturer to ensure that they know who owns/operates the equipment. Thus, it can be difficult for the manufacturer to notify the owner/operator/maintainer, and for the owner/operator/maintainer to learn of these upgrades or improvements to their equipment. Further, it is difficult for the manufacturer to deploy cyber patches to correct known vulnerabilities because they do not know where all of their systems are running and which software the systems are running.

Further, in facilities, such as airports, the status of assets (such as screening equipment) can impact operations. Currently, in an airport if a system breaks, a security officer will notify his/her supervisor, who will call the local operations center to relay information regarding the issue with the particular asset by phone. The operations center then calls the service and maintenance provider, relaying asset information verbally. In some instances, the operations center will also call the airport operations center point of contact as a courtesy, but this is not always the practice. Once the machine has been prepared and put back into use, there is no automated way to inform all relevant stakeholder of this change of status. This manual approach has several drawbacks, including:
Communication Inefficiency. A phone tree approach to getting an asset repaired and notifying relevant stakeholders creates a series of dependencies and delays that could be avoided with a digital tool that directly links appropriate stakeholders with automated notifications.
Limited Information Distribution. The current approach leads to a small group of stakeholders being notified of the event, when a much larger group may have an operational need to know.
Lost Support Opportunity. In an airport, for example, if appropriate personnel are not consistently notified, they cannot support other operating parties in diverting passengers to other checkpoints or through other measures, which is a lost opportunity to enhance collaboration and collective performance.
Sub-Optimal Staffing Allocation. Given that operating parties have limited real-time direct information concerning the repair of an asset, operators or their supervisors who have ended their shift the day with a broken machine do not know what to anticipate when they return the next day—which can hinder staffing allocation efforts.
Incomplete Track Record. Using multiple ways of communicating issues will lead to an incomplete track record for operations. Not only will reporting over the phone not be documented, but it will also lead to an incomplete record when reporting, managing, and monitoring an asset, when managing verbally reported issues, or when assets are monitored using multiple systems which run in parallel (such as an inventory system and a maintenance system).

An asset management system/platform that overcomes these issues would be beneficial to all stakeholders manufacturing, owning, operating and maintaining security equipment.

### BRIEF SUMMARY

The disclosed asset management system is intended to overcome these shortcomings, on one hand, by connecting stakeholders in the asset management ecosystem through a software platform and a universal identification tag which is applied to the individual assets. On another hand, the asset management system digitizes or automates task notifications and communications that are currently done via email or phone allowing for better analytics/trouble-shooting and continuous improvement over time. The notifications and communications provided by the asset management system facilitate monitoring of the status of the stakeholder's assets.

The platform allows users to set and individually configure cadences/schedules for required compliance activities on a per asset basis. As such, the platform provides an overview of all required actions and notes when a task is soon required/failed/overdue. Further, the platform automatically adjusts cadences/schedules for maintenance activities when activities are logged. This ensures people are carrying out the jobs which are necessary in order to stay compliant and in the right time frames. The platform provides a global view into all of these activities providing functionality if necessary and not already covered by another tool. This ensures compliance management happening in one tool collecting all relevant information and connecting all relevant stakeholders. Additionally, platform closes the above-noted communication gap by providing aggregated information about equipment to relevant stakeholders and allows collaboration.

Through the asset management system, a universal identification tag with a unique machine readable ID (such as a QR or similar code) is applied to each individual asset/piece of equipment, and the asset is registered with the asset management system. The asset management system comprises an online platform including an overarching data structure which preferably comprises distinct and separate sub-data structures, there being a separate sub data structure for each “customer” (i.e., owner, manufacturer, distributor, operator, and maintainer) of the platform. The overarching data structure aggregates information by pulling selected data related to the asset at the asset level from the various sub-data structures. The sub-data structures are distinct, such that data is siloed. However, unlike current systems (discussed above), the asset management system pulls the data for individual assets together from relevant sub-data structures in a seamless manner, so that any one customer will have all the relevant information it needs. Thus, via the asset management system, stakeholders (owners/operators/maintainers) can keep track of the current status, location and configuration, as well as of testing, calibrating, and servicing activities of all their assets.

The asset management system also enables owners to provide information to, and receive information from, the manufacturers, operators, service and maintenance entities, regulatory authorities, and manufactures and vice versa, thereby forming a two-way avenue of communication between all interested parties/stakeholders. Further, the platform can anonymize and aggregate information to provide reports, for example, to the manufacture of an asset, based on the aggregated information. Thus, a manufacturer can receive information regarding a particular equipment model, but will not be able to determine which entity uploaded information regarding a particular asset. Many of the security assets currently in, for example, airports, are not networked. However, for assets that are networked or which can be provided with communication functionality, the platform could receive information directly from the assets, thereby enabling the platform to aggregate data from different makes/models of networked assets across vendors/manufacturers. Through the platform, manufacturers, owners, and operators can determine where their asset(s) is (are) used and can receive notifications regarding testing or calibration which are not isolated to a single owner/operator. This enables the operator or manufacturer to learn of what may be an endemic issue at an earlier time than is otherwise currently possible. Through the asset management system/platform, the vendor or service provider can register/push data from a system that is outside a customer's network and push updates securely to the owner/operator. Currently, this is very difficult for owners, as they cannot expend the resources to register and let numerous different actors (operators, service providers, etc.) into their own network.

As will become more apparent from the description below, the asset management system/platform, greatly enhances the ability for stakeholders to (1) know what assets they have, (2) monitor the status of their assets, (3) via maintenance/testing schedules or quality assurance cadences, keep better track of when testing and maintenance is required, (4) receive updates and new information regarding their assets, and (5) communicate with different stakeholders. From the manufacturer's standpoint, the asset management system can enable the manufacturer to more easily ensure that the appropriate stakeholders receive updated information regarding assets and to receive (anonymized) information from the stakeholders regarding products produced by the manufacturer.

### BRIEF DESCRIPTION OF THE DRAWINGS

FIG. 1 is a schematic of the components of an asset management system;

FIGS. 2A and 2B are block diagrams of a computer system and a user device, respectively, which are used with the asset management system;

FIG. 3A contains a non-exhaustive list of data elements contained in a data structure of the asset management system;

FIG. 3B is a schematic diagram showing siloing of data for the asset management system among separate and distinct sub-data structures and the flow of data through the asset management system for viewing and use on in a User App on a User Device;

FIG. 3C is a schematic showing the flow of data between two-sub data structures to enable a customer to have complete data of an asset;

FIGS. 4A-E, in combination, are block diagrams of a domain model of the asset management system;

FIG. 5 is a diagrammatic flow chart of the onboarding process of an asset into asset management system from the perspective of an owner/operator;

FIG. 6 is an alternate flow chart of the onboarding process showing the status of an asset after onboarding into the asset management system;

FIG. 7 is a flow chart of a method of onboarding an asset into the asset management system by an owner/operator;

FIG. 8, comprised of FIGS. 8(1) and 8(2), is a screen shot of an inventory screen of the asset management system;

FIGS. 9A-C are overlapping screen shots of an asset identification/asset on-boarding pop-up or screen;

FIGS. 10A-C are overlapping screen shots showing a drop down list enabling selection of the asset type from among the list of homogenized asset type names to facilitate filtering of the assets;

FIG. 11, comprised of FIGS. 11(1) and 11(2), is a screen shot of a detail tab of an asset detail screen of the asset management system;

FIGS. 11A-B are screen shots of a pop-up screens for configuring the maintenance and testing schedule or cadence for an asset;

FIG. 11C is a screen shot of an Asset Status Change pop-up;

FIG. 11D is an enlarged screen shot of the configuration tile of the asset details screen;

FIG. 12A is a screen shot of a testing history screen;

FIG. 12B is a screen shot a pop-up window for recording the results of a test of an asset;

FIG. 13A is a screen shot of a work order management tab of the asset detail screen;

FIGS. 13B-C are enlarged views of the top and bottom portions of the work order management tab of FIG. 13A;

FIG. 13D is further enlarged view of the top portion of the work order management tab screen;

FIG. 13E is a two-piece screen shot of a “Create Work Order” pop-up;

FIG. 13F is a two-piece screen shot of a “Create Work Order” pop-up showing a completed work order;

FIG. 14 is a screen shot of an Activity Log tab of the asset detail screen;

FIG. 15 is a graphical representation of the flow of information in the asset management system;

FIG. 16 is a screen shot of a user management screen of the asset management system; and

FIG. 17 is a screen shot of a location (airport) editing screen.

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what is presently believed to be the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

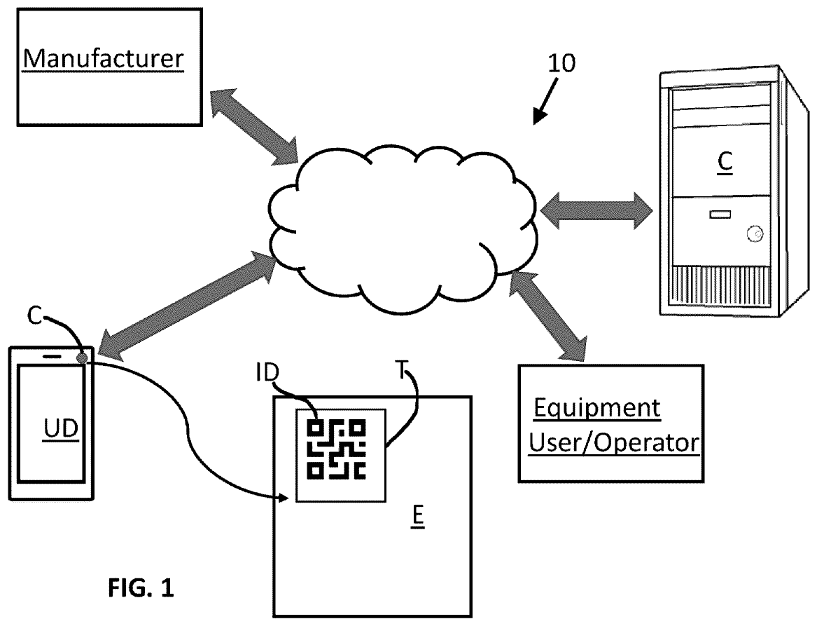

Initially, FIG. 1 shows a schematic of the components of the asset (or equipment) management platform or system 10. The asset management system includes a computer system C, a plurality of user devices UD which are used by technicians, owners, etc. to manage their equipment or assets, and asset tags T. A separate asset tag T, bearing a universal identification code ID, is applied to each individual asset or piece of equipment/asset E. The identification code (or asset ID) is unique for each asset, such that no two assets will have the same identification code. The computer system can comprise a general purpose computer, a server computer, or could even comprise a plurality of interconnected computers. The user device UD can be laptop computers, tablet computers, personal devices, virtual computers, dedicated terminals, or the like.

The asset tag T can be a printed tag (i.e., sticker) having an adhesive back enabling the asset tag to be applied to a particular asset. In this instance, the identification code on the asset tag will be encoded in a 2D bar code or a quick resource (QR) code printed on the tag, or a 3D bar code engraved or etched on a tag or directly on the asset. Alternatively, asset tag T can be an RFID tag which is adhered to the asset E and which is programed with an identification code. In such an instance, the RFID tag is read-only RFID tag, such that the identification code cannot be changed once programmed into the RFID tag. In another alternative, the tag T can comprise a read-only NFC (near field communication) tag containing the identification code. As can be appreciated, any other type of asset tag can be used, as long as the asset tag is capable of being provided with an identification code which can then be read or otherwise perceived by the user device UD. Regardless of the type of tag (i.e., printed sticker, RFID tag, etc.), the identification code (which, preferably, is alphanumeric) is preferably also printed on the tag T in human readable form as a cross-check when the asset management system is being used.

As will be described below, the asset management system 10, with the use of the asset tags T provides centralized (and near real-time) asset monitoring and management platform, complete with a documented activity history. This documented activity history includes activities such as onboarding of the asset into the asset management system, asset status, location changes of the asset, testing and calibration, asset upgrades, service and maintenance of the asset, etc. Thus, the asset management system provides a single source containing not only all relevant assets, but the full history of the assets, including all activities happening with and around the asset. Further, the asset management system can provide the operator/user with all necessary documentation for the asset. This documentation can include qualification certificates, operating manuals, service manuals, etc. Additionally, the asset management system can retain historical documentation for the asset. That is, if, for example, an operating manual is updated, the asset management system can store both the current operating manual and prior operating manual(s). The asset management system can also include relevant regulatory information available from regulatory sources about specific equipment. Thus, the asset management system pulls external data which may be relevant to the use, operation, and maintenance of an asset. Further, the asset management system or platform enables the sharing of data with parties who have a “need to know” in view of a collaboration with the owners, manufacturers, service providers, and/or operators without such other parties (i.e., a service provider) accessing the systems for, for example, an owner. For example, when an airline tags its assets, the airport (i.e., a “collaborating party”) can, through the asset management system, view information related to the asset and receive automated notifications regarding an asset. In this manner, the airport can, for example, receive a notification that a security scanner has gone down (i.e., become non-functional), and will thus be able to redirect parties (i.e., passengers) to other checkpoints, etc.

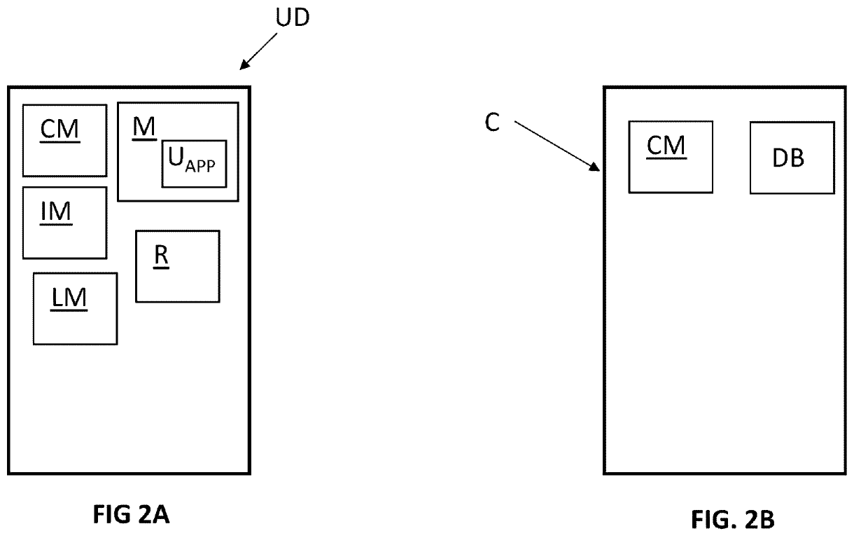

With reference to FIG. 2B, the computer system C includes a memory CM (such as non-volatile memory) on which is stored software S and an associated data structure DB. The software comprises appropriate instructions or coding to enable the asset management system as described below to operate and be used. The computer system C can be centralized (i.e., reside on a single computer). Alternatively, the computer system can be decentralized, wherein various components of the computer system reside in disparate computers. Further, the computer(s) of the computer system C can be physical computers or virtual computers. The software comprises coding or computer logic necessary to carry out the functions described. A main component of the asset management system is the data structure DB which is stored in a non-volatile memory CM of the computer system C. As such, the software can be programmed in any language that is sufficiently robust to carry out the functions described below.

The data structure DB includes information related to the assets and customers (owner, manufacturer, distributor, operator, and maintainer). Following is a non-exhaustive list of information that can be included in the data structure.
Asset information (for specific asset)
   Asset Tag Identification Code
   Type of asset (e.g., baggage scanner, passenger scanner, X-ray machine, explosive detection system, security scanner, walkthrough metal detector, etc.)
   Asset manufacturer, make, model number, and serial number
   Software version
   Hardware version
   Supported auxiliary hardware
   Install date and End of Life date
   Service history (including audit trail) and next service date
   Maintenance/repair history (including audit trail)
   Testing/calibration history (including audit trail) and next testing/calibration date
   Update logs (including audit trail)
   Alerts
      Non-compliance
      Software upgrades
      End of Life
   Asset Usage Category (active/spare/decommissioned) and Operability Status (operable/inoperable)
Asset model information information (for asset models)
   Asset manufacturer, make, and model number
   Jurisdictions in which asset is certified for use
   Certification letters
   Model specific documents (e.g., manuals, guides, warranties)
   Manufacturer notices (e.g., changes in recommended procedures)
   Asset software/drivers
   Warranty timeline.
Qualification List harmonization information (for asset models)
   Technology qualification authority and/or manufacturer name for asset type
   Concordance of asset types with asset manufacturer make and model and/or technology qualification authority name for the asset type
User information
   Username, User ID, and password
   User rights
Owner information
   Owner name (e.g., airline, airport)
   Owner ID
Operator information
   Operator name (e.g., airline, airport)
   Operator ID
Maintenance/Service provider information
   Maintainer Name
   Maintainer ID
   Start and end of service and maintenance agreement
   Service Level Agreement (SLA) requirements
Location information
   Facility location name
   Facility location codes
   Facility location (city, state, country)
   Specific location within the facility

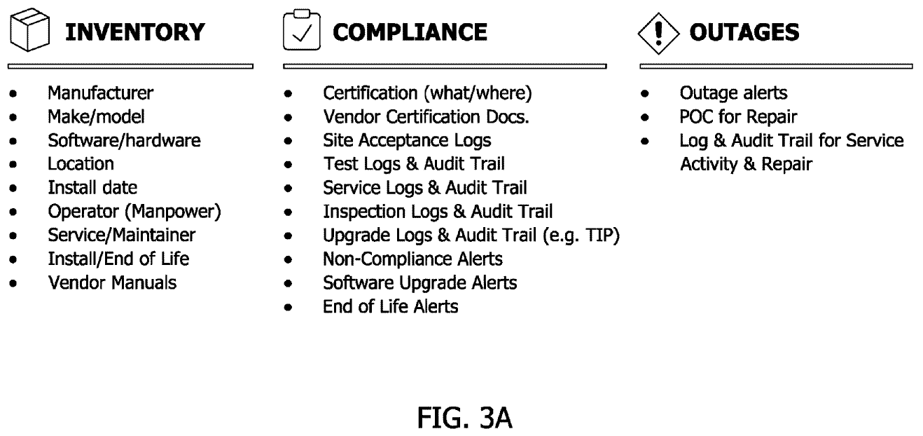

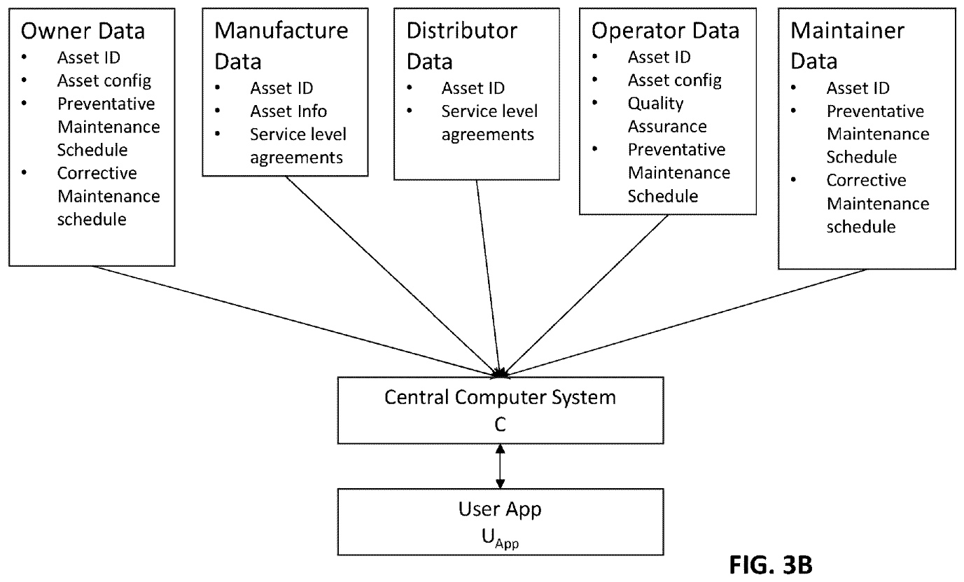

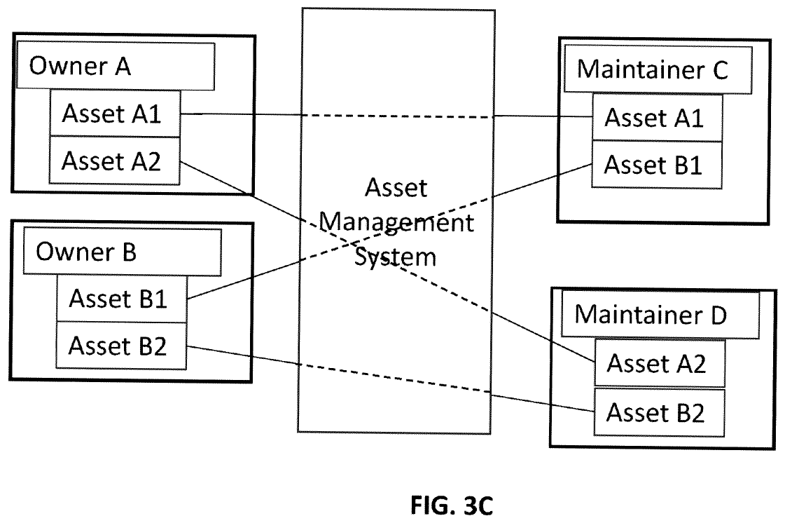

Some of these data points are shown in FIG. 3A. It is understood that not all assets will need all the information listed above, and that some assets might require additional information not listed. Thus, the above list of data points stored in the data structure is illustrative, and is not to be considered exhaustive. It will be understood that the computer system C of FIG. 2B is a schematic figure, and that although the data structure DB as shown in FIG. 2B could be interpreted as residing in a single computer, the data of the data structure DB could be dispersed among several different physical or virtual computers.

Further, although the data structure could be a single comprehensive database structure (such as a relational database), the data structure is preferably comprised of separate and distinct sub-data structures as shown in FIG. 3B, with there being a separate sub data structure for each “customer” (i.e., owner, manufacturer, distributor, operator, maintainer) of the asset management system which, in combination form an overarching data structure. The sub-data structures are physically separate from each other and are not interconnected. That is, there is no direct link between the sub-data structures. Each sub-data structure will contain a subset of all the data for an asset. An example of some of the different information that can be contained in the different sub-data structures is shown in FIG. 3B and in the table below. It will be appreciated that the information contained in the different sub-data structures, as shown below, could be reorganized, and that additional or different data could be included in each sub-data structure. Thus, the table below is purely illustrative.

| Owner | Manufacturer | Distributor | Operator | Maintainer |
|---|---|---|---|---|
| Asset ID | Asset ID | Asset ID | Asset ID | Asset ID |
| Owner Info | Mfg. Info | Distributor Info | Operator Info | Maintainer info |
| Purchase date | Serial No. | Distributor Sale Date | Configuration(s) | Corrective Maintenance Schedule |
| Install date | Product No. | Service labor agreements | Quality Assurance | Preventive Maintenance Schedule |
| Configuration(s) | Manufacture date | | Testing Schedule | Maintenance information |
| Asset location | Mfg. Sale date | | | |
| | Manuals | | | |

As noted, the sub-data structures are distinct and separate from each other, such that the data in one sub-data structure is not, except via the asset management system 10, associated with data in another sub-data structure. Thus, someone gaining access to, for example, the owner sub-data structure, would not obtain access to the other sub-data structures. The asset management system enables various customers to view data from other customers' sub-data structures based on their respective log-in permissions or credentials using the user app Uₐₚₚ, such that a user will have the data it needs. Thus, in use, when a user, via the User App accesses the record for a particular asset, the User App will, as shown in FIG. 3B, send a request to the computer system C, which will then access the data for the asset from the sub-data structures. In this manner, all requests go through the computer system, and there is no direct communication or connectivity with between the various stakeholders or their respective sub-data structures This is schematically shown in FIG. 3C. As seen there in, owner A has assets A1 and A2, owner B has assets B1 and B2, maintainer C maintains assets A1 and B1, and maintainer D maintains assets A2 and B2. Based on their permissions/credentials, Owner A can view via the User App the data for its assets A1 and A2 from Maintainer C and D, but will not be able to see information regarding Owner B's assets. Similarly, Owner B can view via the User App the data for its assets B1 and B2 from Maintainer C and D, but will not be able to see information regarding Owner A's assets. Conversely, Maintainer C will have access, through the User App, to the information from Owners A and B regarding Assets A1 and B1, but not assets A2 and B2, which are maintained by Maintainer D. Similarly, Maintainer D will have access, through the User App, to the information from Owners A and B regarding Assets A2 and B2, but not assets A1 and B1, which are maintained by Maintainer C. The asset management system 10 will obtain the relevant information regarding an asset from necessary sub-data structures to display information which a particular user needs to be able to see.

A user accesses the platform/asset management system via logging in using the User App on a User Device D. Preferably the platform requires multi-factor authentication. However, the initial log-in may entitle the user to only a certain level of information, thus reducing the need for multi-factor authentication at log-in. In this instance, some information may require the user to use a second level of multi-factor authentication to be accessed. For example, access to information regarding the exact location of an asset could be restricted in this manner.

Security-related assets can be categorized into different types, such as explosive detection systems, explosive detection system for cabin baggage, explosive dog detection, explosive trace detection, handheld metal detection, liquid explosive detection, metal detection, security scanners, shoe explosive detection, shoe metal detection, walk through metal detection, etc. Different manufacturers and different jurisdictions provide different names for the same types of security assets. Thus, two manufacturers or two jurisdictions may have different names for the same type of security asset, for example, handheld metal detectors. As can be appreciated, the plethora of different names used by different authorities and manufacturers for the same type of asset can make it difficult to sort a list of security assets by type (thus making it difficult to determine what types of security assets the owner/operator has and where the security asset is located) and to determine if a particular security asset is certified for use in a particular jurisdiction, as this would require knowledge or understanding by the owner/operator of the various names used by the different certifying jurisdictions for a particular security asset. The Qualification List Harmonization information provides a harmonized list of names for the various types of hardware elements that may be used in a security zone, and thus the owner/operator does not need to familiarize itself with the numerous different names that may be used for the particular type of security asset. The Qualification List Harmonization information is contained in a separate sub-data structure which is maintained by the system operator for the asset management system 10. Having a single name (or common nomenclature) for the security asset type (e.g., body scanner), which the owner/operators can use and rely upon makes it easier for the owner/operators to on-board the owner/operators' assets into the asset management system, determine what types of security assets they have, where the security assets are located, and if the security assets are certified in the jurisdiction in which they are located. Although the Qualification List Harmonization information is described for use in harmonizing names of security-related equipment, such as used in airports, the Qualification List Harmonization information could be used with assets (such as baggage return systems) that are not security-related assets. Similarly, it will be appreciated that the Qualification List Harmonization information can be applied in other industries (such as federal facilities, laboratories, nuclear facilities, and hospitals) where the equipment that is monitored is not strictly an asset associated with security for the facility.

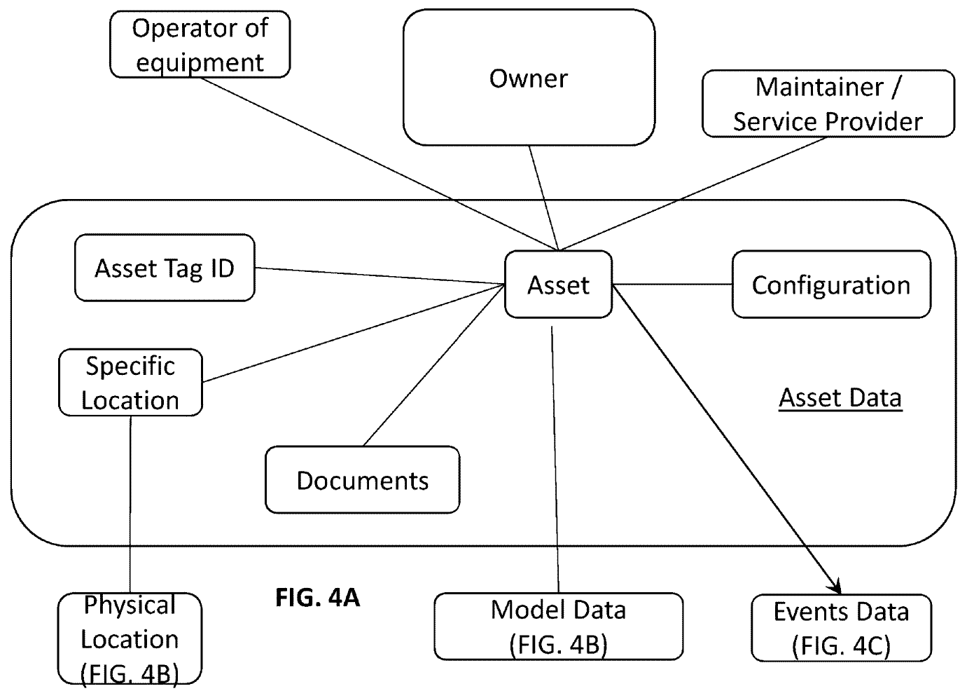

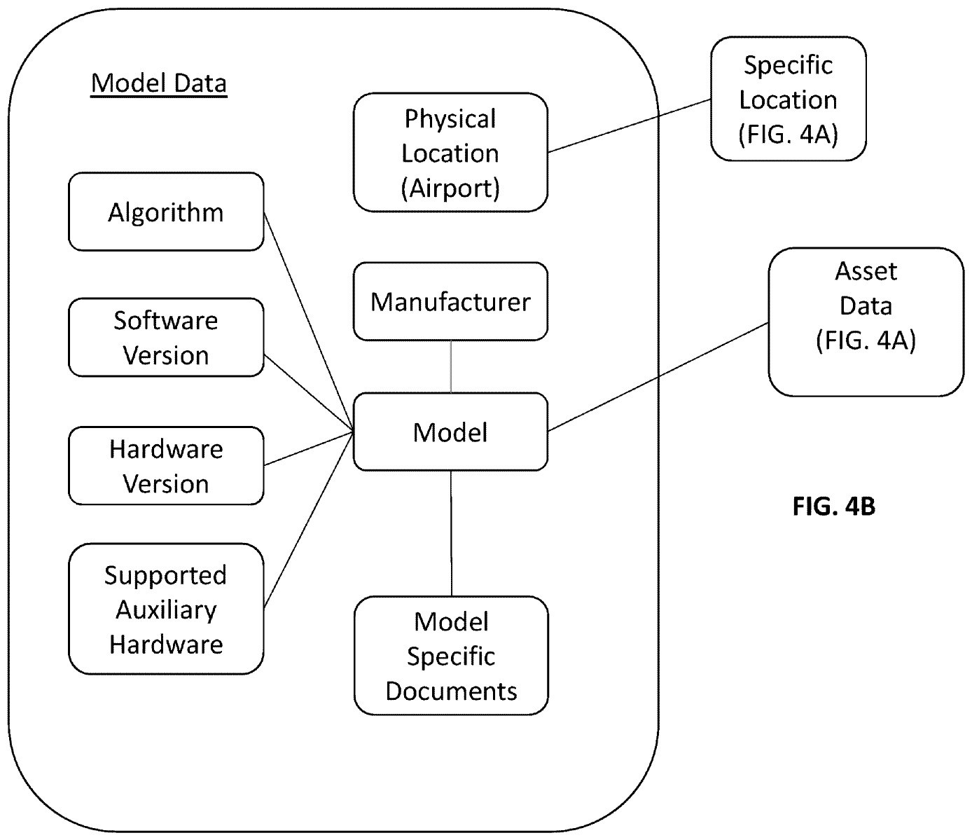

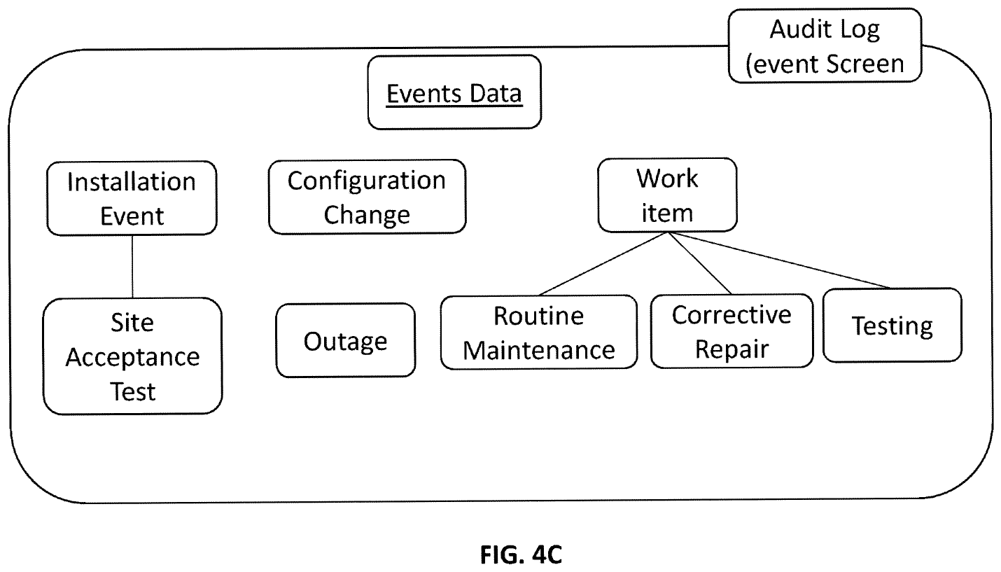

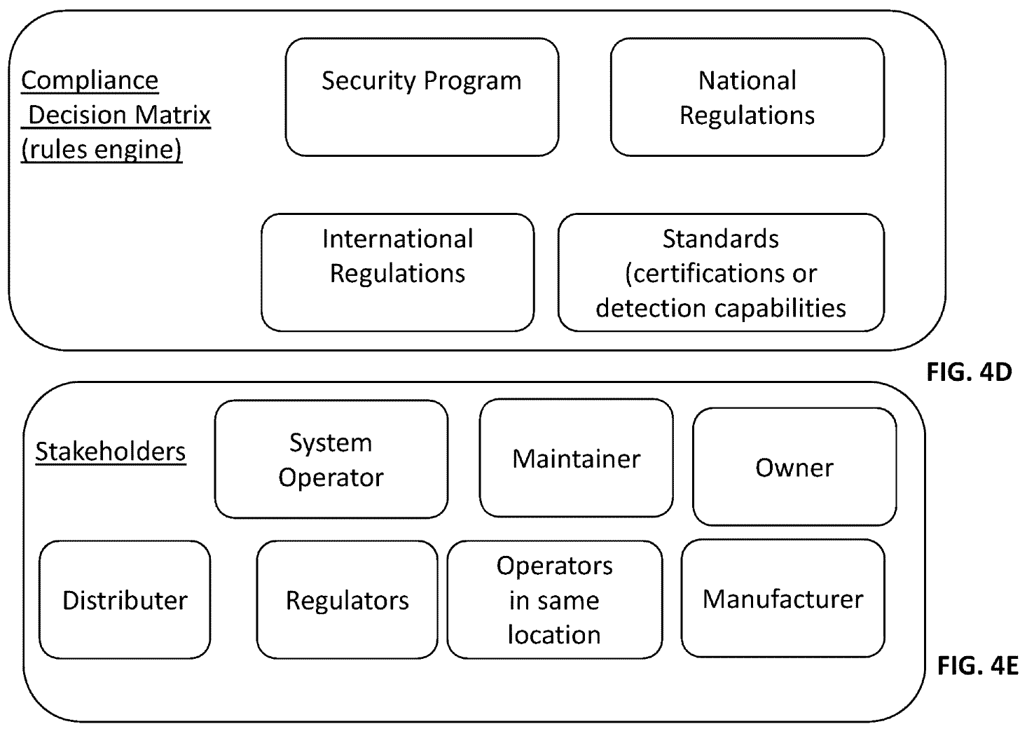

The flow of data from the sub-data structures and the use of the data by the asset management system is shown graphically in the Domain Model of FIGS. 4A-E. As will be described below, those who operate, maintain, and/or own an asset interact with the overarching data structure through their user devices UD via a portal, with all information flowing through the central computer system C. The overall asset management system is maintained by a System Operator which engages with asset manufacturers to keep asset information (such as operating manuals, recommended service schedules and tasks, etc.) current. Alternatively, the System Operator could obtain such asset information from publicly available qualified product lists. The System Operator also engages with regulators from the various jurisdictions to maintain the certification status of the various assets in each of the jurisdictions. Additionally, the System Operator will maintain the Qualification List Harmonization information. The users (asset owners, operators, service providers, etc.) then use the asset management system, as noted above, to monitor, service, and maintain the assets, as described below.

The asset management system, with the use of the asset tags, as alluded to above, enables the tracking of the status of any asset having an asset tag, and will provide a complete history of the asset by bringing together in a series of screens (as described below) all the information related to an asset. Such information may include the asset's current usage category (i.e., active/spare/decommissioned) and operability status (operable or inoperable), a history of work performed (i.e., servicing, maintenance, repair) on the asset, the identity of those who conducted the service, etc. The information may also include location information for the asset. Location information can be merely the city, state, and country in which the asset is located (for purposes of determining its certification status). Preferably, location information includes at least the facility (i.e., particular airport) in which the asset is located or even the specific location within the facility. Finally, the information may also include any other appropriate information, such as the date/time that particular events with respect to the asset occurred. This list of information regarding the asset is not to be considered to be exhaustive. The information displayed regarding an asset to a particular user will depend on the type of asset (certain information relevant to one asset may not be relevant to another asset) and the permissions accorded the particular user.

Additionally, the asset management system includes relevant data from external systems (such as, for example, relevant regulatory information, asset information from the manufacturer, etc.) which can be accessed, for example, via an application programming interface (API) between the computer system C and the provider (regulator, manufacturer, etc.) of such external data. Thus, the asset management system is more than a repository of the “immediate” information regarding the asset and its maintenance/repair history. Rather, the asset management system includes other external data relevant to the asset, making the asset management system 10 a “one stop shop” or dashboard for all the information related to the particular asset.

The user device UD (shown schematically in FIG. 2A) by which the asset management system is accessed is preferably a handheld device (such as a smart (cellular) phone or tablet computer), but can also be a laptop computer, a virtual computer, a dedicated terminal, or any other device which enables the user to access the platform. With reference to FIG. 2A, each device UD includes a memory M in which is stored a user application U_{APP} utilized by a user (i.e., owner/operator) to access the asset management system and to monitor, service, and maintain assets in one or more facilities. To this end, each device has a reader or sensor R which is capable of perceiving and reading the asset tag T. The reader R can, for example, comprise a camera if the asset tag is a printed tag or an RFID or NFC reader if the asset tag is an RFID or NFC tag. The user device is equipped with a communication module CM which enables the user device UD to communicate with (i.e., send information to and receive information from) the computer system C. Such a communication module can enable communication with the computer system, for example, over a local area network (LAN) or over a wide area network (WAN), including the internet, via HTTP protocol, or can enable direct wireless communication via a cellular network, for example, using 5G technology. Other currently known, or to be developed wireless communication systems can be used as well. To facilitate communication with the computer system, the user device UD includes an input module IM which can comprise one or more of a keyboard (preferably a virtual keyboard), a touchscreen, a microphone (for sound or voice recordings and/or dictation), and a camera or code-reader. Any other method currently known or later developed for identifying a particular asset could be used. Additionally, the device can include a location module LM (such as a GPS) which would provide information regarding the current location of the user device, and enable the asset management system to determine which asset(s) are in the same location (airport, airport terminal, etc.) as the user.

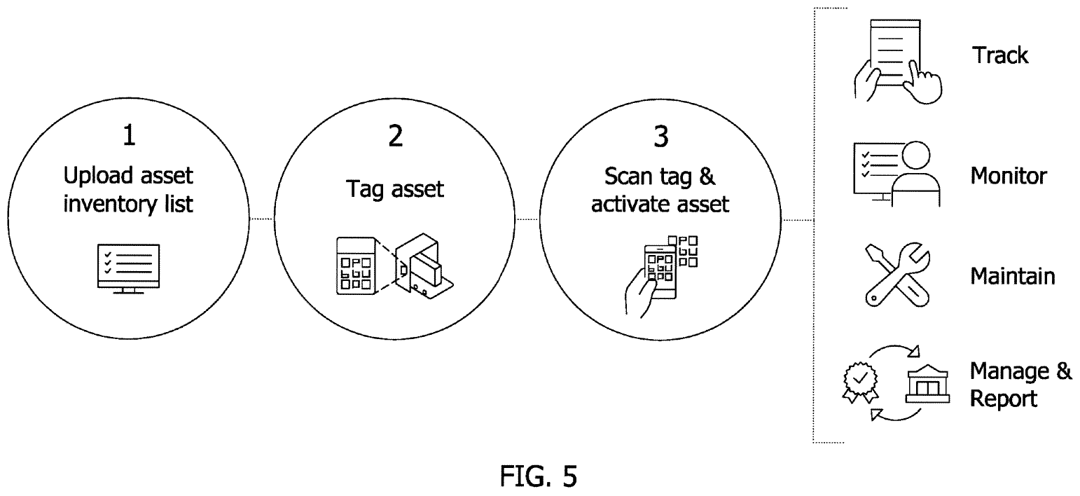

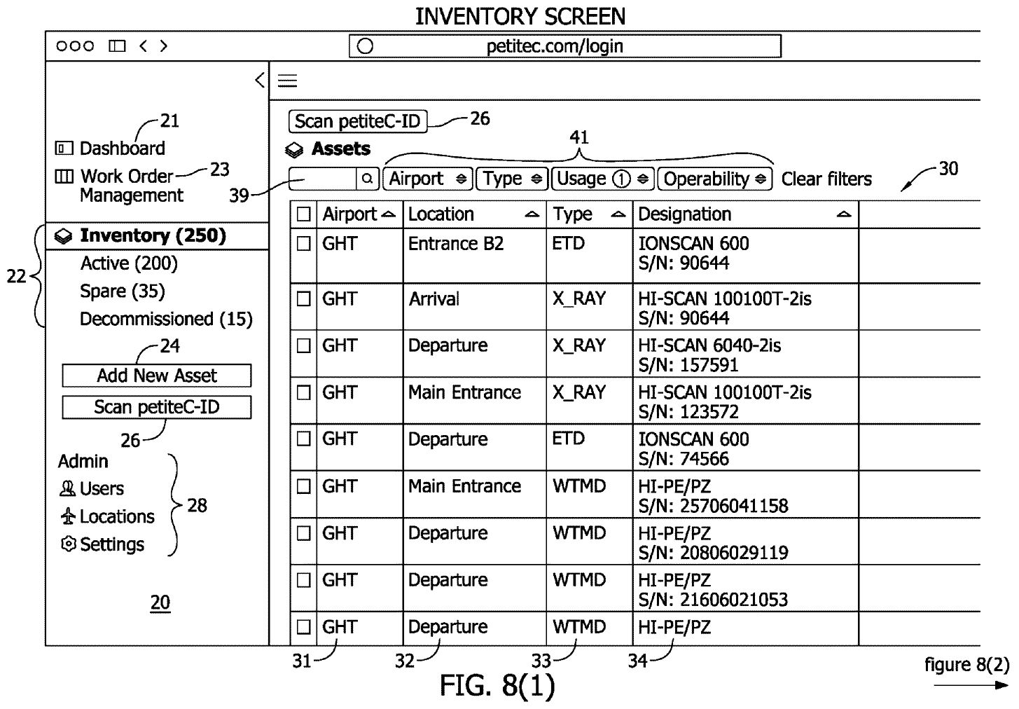

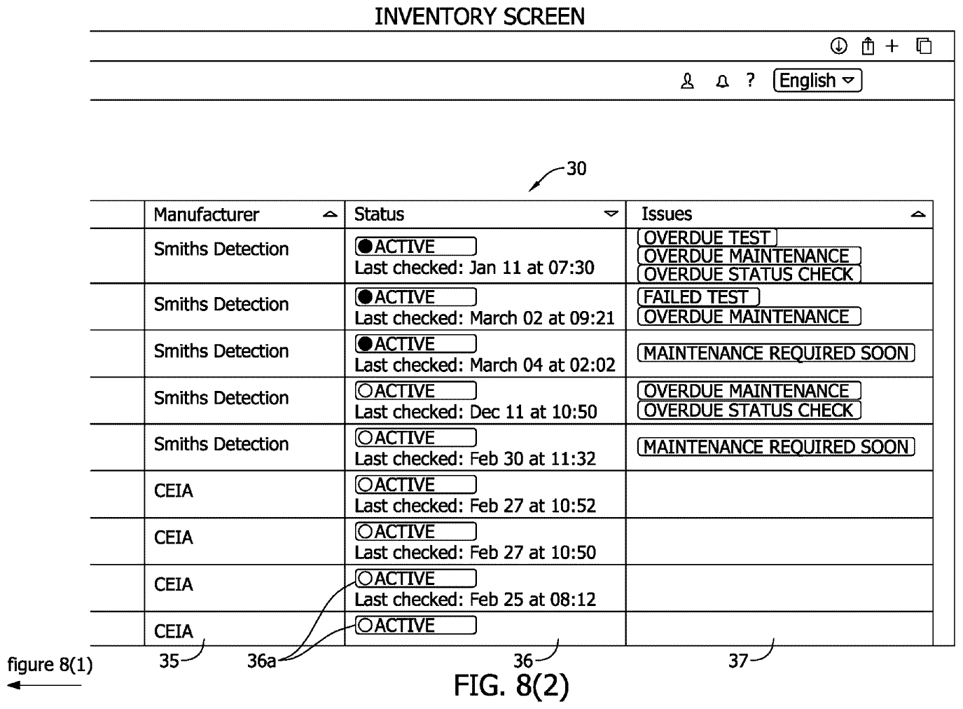

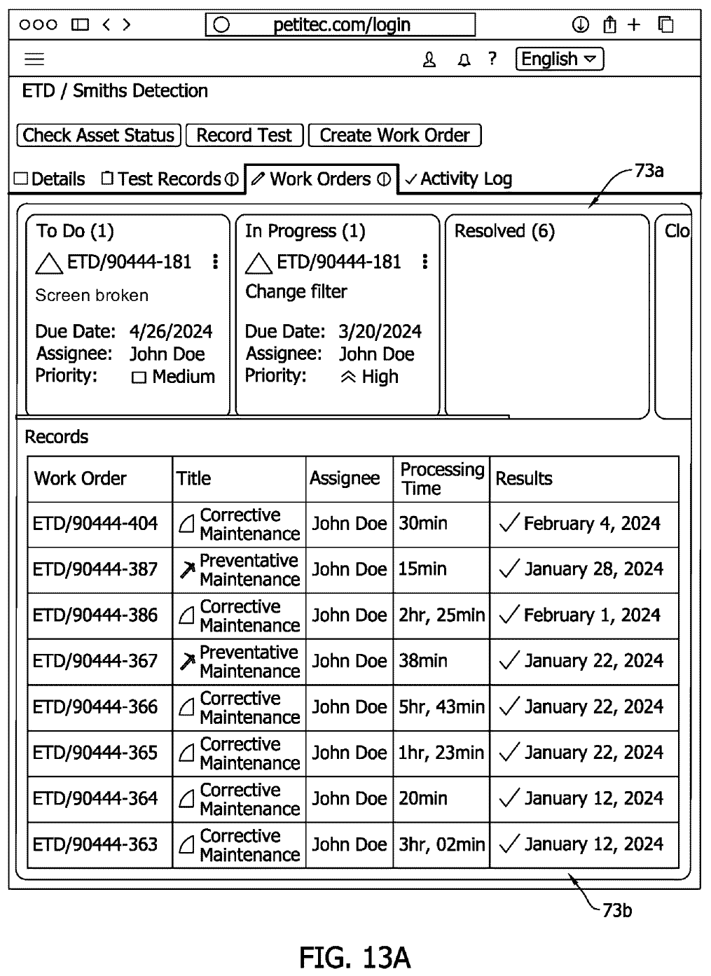

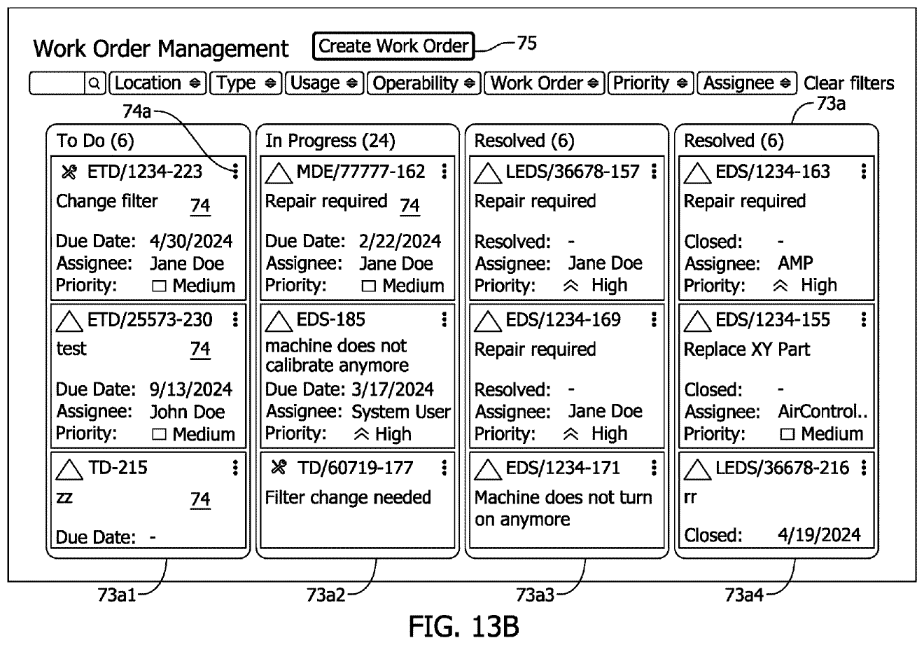

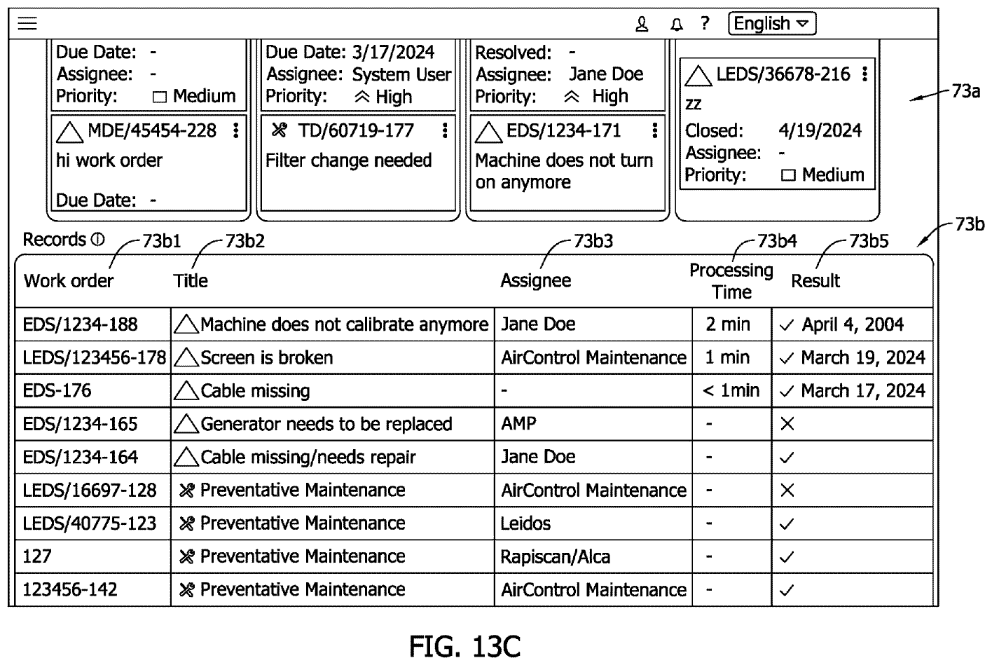

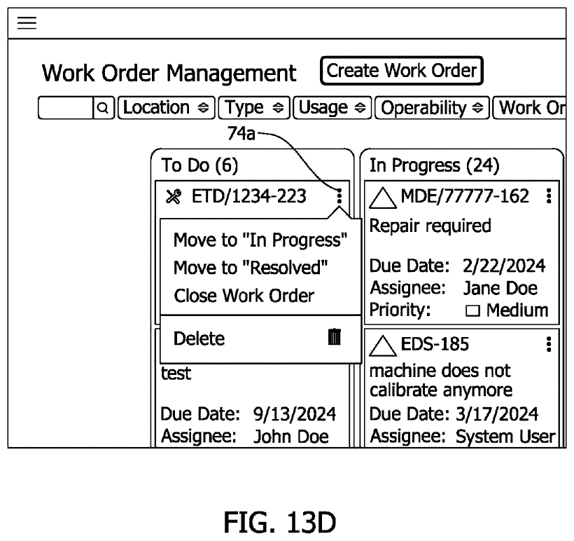

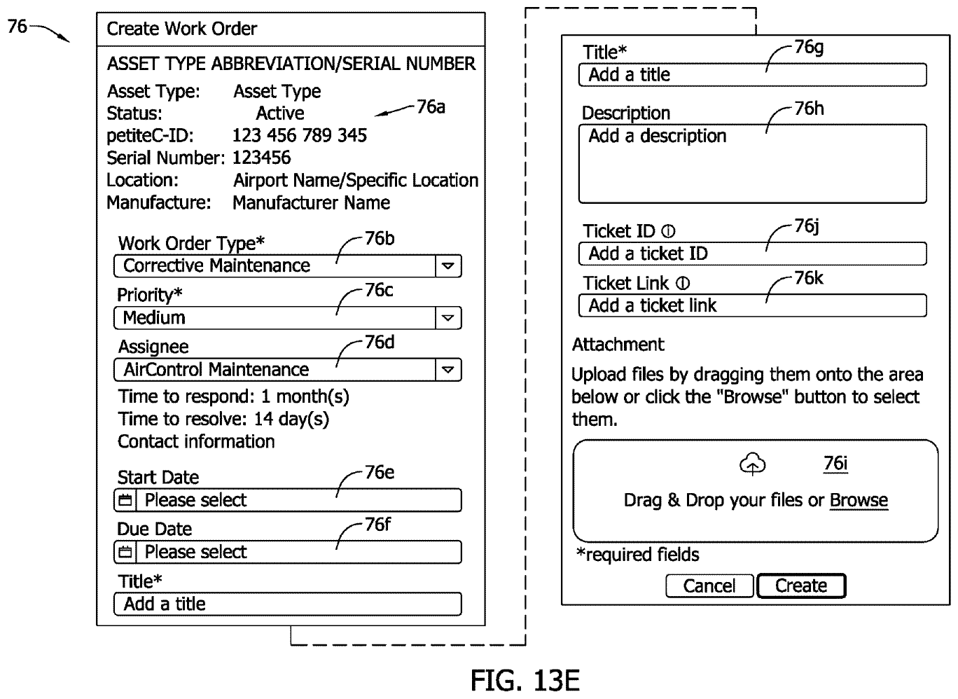

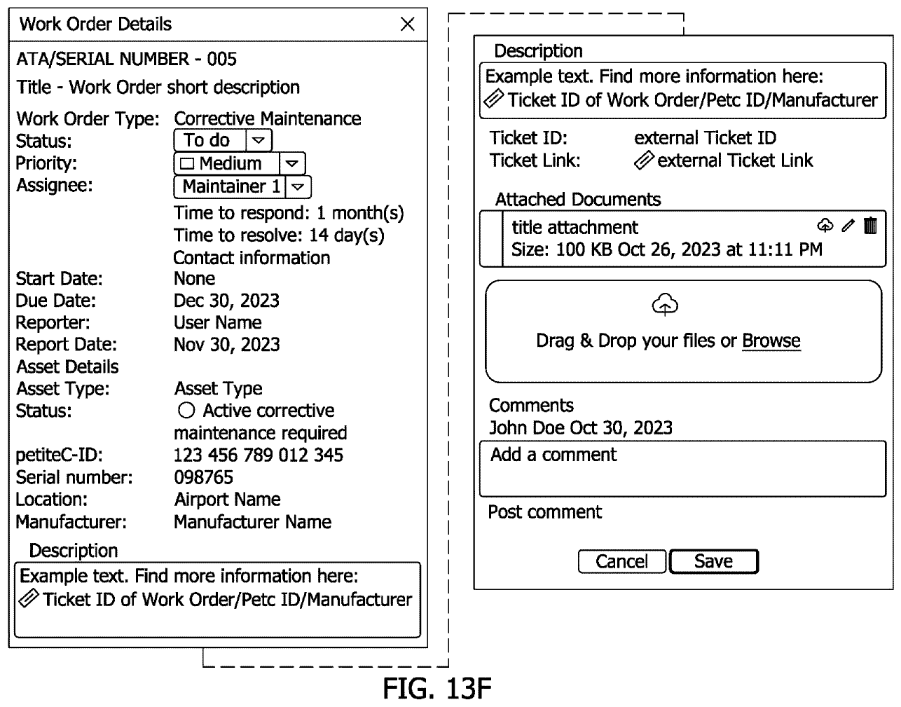

General use of the asset management system is shown schematically in the right side of FIG. 5. The user, i.e., the owner or operator (servicer or maintainer) logs into the asset management system 10 using the application U_{APP} on a user device D. As noted above, the user is preferably required to use a form of two-factor authentication to log in. Upon login, the user will be presented, for example, with an inventory screen, such as shown in FIG. 8. The user can, using the device, scan the asset tag of a particular asset or select a particular asset from the inventory list to complete a number of tasks, as will be described below. With reference to FIG. 8, this main screen includes a menu field 20 shown on the left side of the window. The Menu Field 20 is preferably constant, and is visible and accessible regardless of the screen of the asset management system (to be described below) which the user currently has open. In the upper portion, the menu field includes a dashboard link 21 and a work order management link 23. The dashboard link 21, when clicked, will return the user to the inventory screen of FIG. 8. The work order management link 23, when clicked will bring the user to the asset management system's work order management module (FIGS. 13A-F, described below). Below the work order management link, the menu includes an inventory status summary 22 which provides the total number of assets in inventory, how many of the assets are active, spare, or decommissioned. If desired, the screen could also show the number of assets for which on-boarding has started, but needs to be completed. Below the inventory status summary 22, the menu field 20 includes an “Add New Asset” button 24 and “Scan ID” button 26. Below this, are administrative functions 28, including a “user” menu, a “location” menu, and a “settings” menu.

The main portion of the Inventory Screen (FIG. 8) comprises an inventory table 30 containing a row for each individual asset that has been onboarded into the asset management system. The assets listed in the inventory table includes only the assets for which the particular user has credentials or permissions to view. Thus, a user will not be able to see assets for which the user does not have permission to see. For each asset, the inventory table includes columns for location (e.g., airport) 31, specific location within the facility 32, type of asset 33, asset designation (or model) and serial number 34, manufacturer 35, asset status 36, and issues 37. The asset inventory table 30 can be sorted on any of the columns. The location (“airport”) column 31 shows a code for the location. This code can be a standard well-known location code (such as ORD for O'Hare Airport in Chicago) or an internal code for the location such that the actual location is not obvious. In this latter case, the asset management system would have a concordance between the internal code and the location. This concordance could, for example, be part of the location sub-data structure. In another alternative, the actual name of the location could be displayed. The asset type column 33 shows the asset type using a designation code from the Harmonization information, described above. The status column 36 notes whether the asset is active, spare, or decommissioned, and includes a visual indicator 36a in the form of a dot adjacent the status indicative as to whether or not the asset is operable or inoperable. For example, a red dot adjacent an “active” status can indicate that corrective maintenance is required or that preventative maintenance is in progress and that the asset is inoperable. The “issues” column 37 will note the issues for each asset such as if the asset failed a test, has overdue maintenance, overdue testing, an overdue status check, or if a prescribed activity has not been completed within the timeframe required. If the particular asset has no issues and is operable and available for use, the status column can be empty (as shown in FIG. 8) or it can include a “ready” icon, which can, for example, be green. The issues shown in the issues column can be color coded. For example, issues relating to failed tests, overdue maintenance, overdue testing, or overdue status check can be red and less urgent issues, such as notices requiring that “maintenance is due soon” can be in yellow. On the other hand, if the particular asset needs testing, servicing, maintenance, or repair, an appropriate icon 36a, which can, for example, be red is displayed in the status column. The icons can be images and/or can contain descriptive words. By having the icons be color coded (i.e., green or red), a user will be able to quickly determine which assets need attention. Additionally, above the title bar of the asset table, the inventory screen includes a search bar 39 and filters 41. The search bar 39 allows the user to search for specific assets by any data related to the asset (such as type, manufacturer, purchase date, location, etc.). The filters 41 are preset filters to show only assets corresponding to the filter(s) selected. These preset filters include filters for “airport” (or location), asset “type”, “usage” category (active, spare, decommissioned), and “operability” status (operable, inoperable). Adjacent the filters is a “clear filter” button, which when clicked, will clear the filter to display all the assets available to the user in the asset table 30.

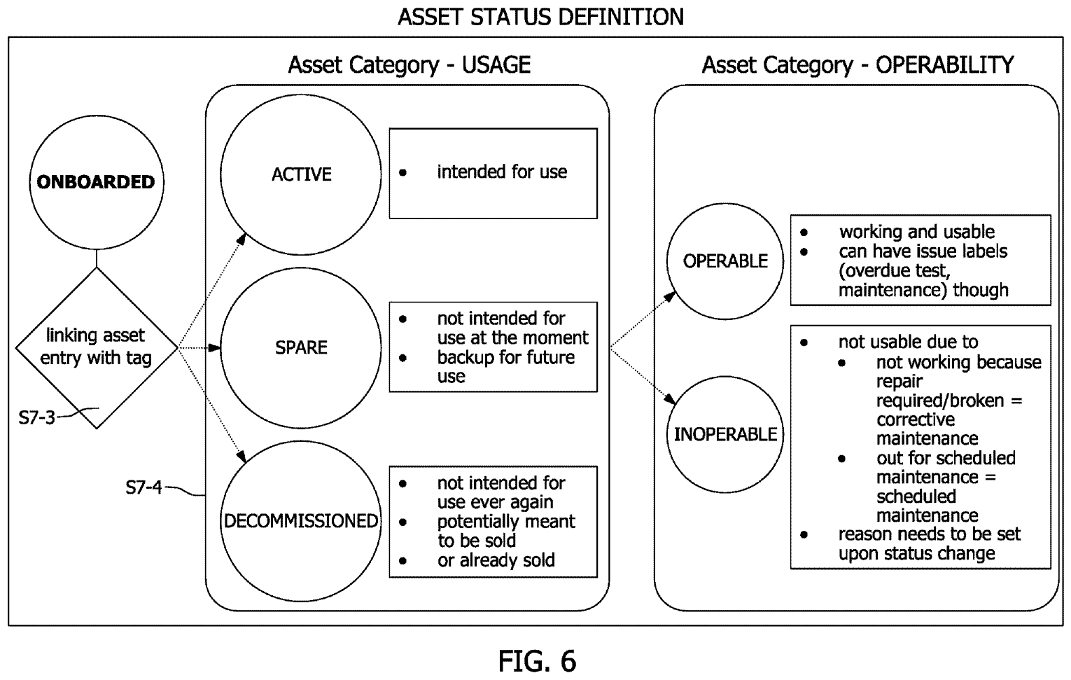

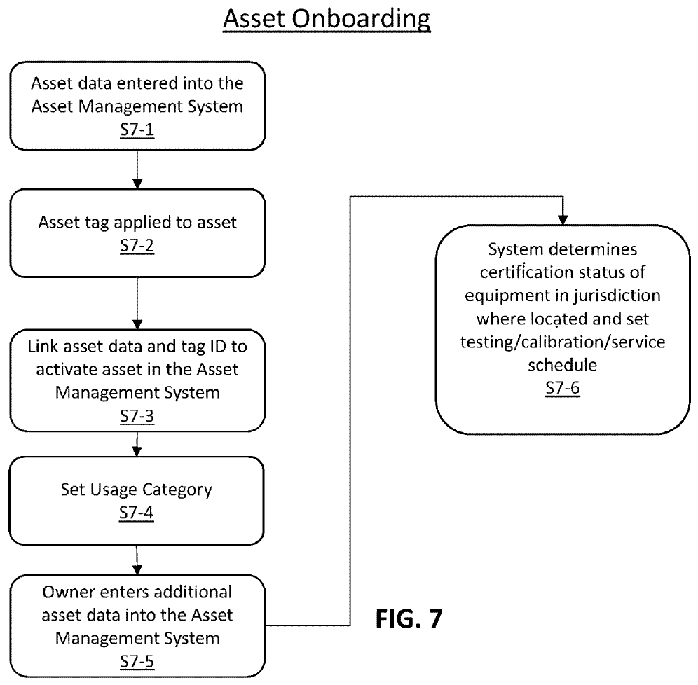

Initially, for an asset to appear on the inventory screen, each asset must be added to, or on-boarded to, the asset management system. FIGS. 6 and 7 show the onboarding of an asset. Initially, at step S7-1 asset data is entered into the asset management system. This information can include the following: the type of asset, the manufacturer, the model, and the screening application for which the asset is used. This list is not exhaustive, and the data that is entered will depend on the type of asset.

At step S7-2, an asset tag is applied to the asset. These two steps can be performed by the owner/operator or by the manufacturer or distributor, and could be reversed in order. If the owner/operator enters the asset information and applies the asset tag, the owner/operator can receive tags from the system operator which are encoded with identification codes, and the owner/operator can the apply the asset tags to assets as assets are acquired and need to be onboarded. On the other hand, if the manufacturer performs these initial steps, the manufacturer or distributor is provided with the asset tags, and applies the asset tags to asset as part of the manufacturing or distribution process.

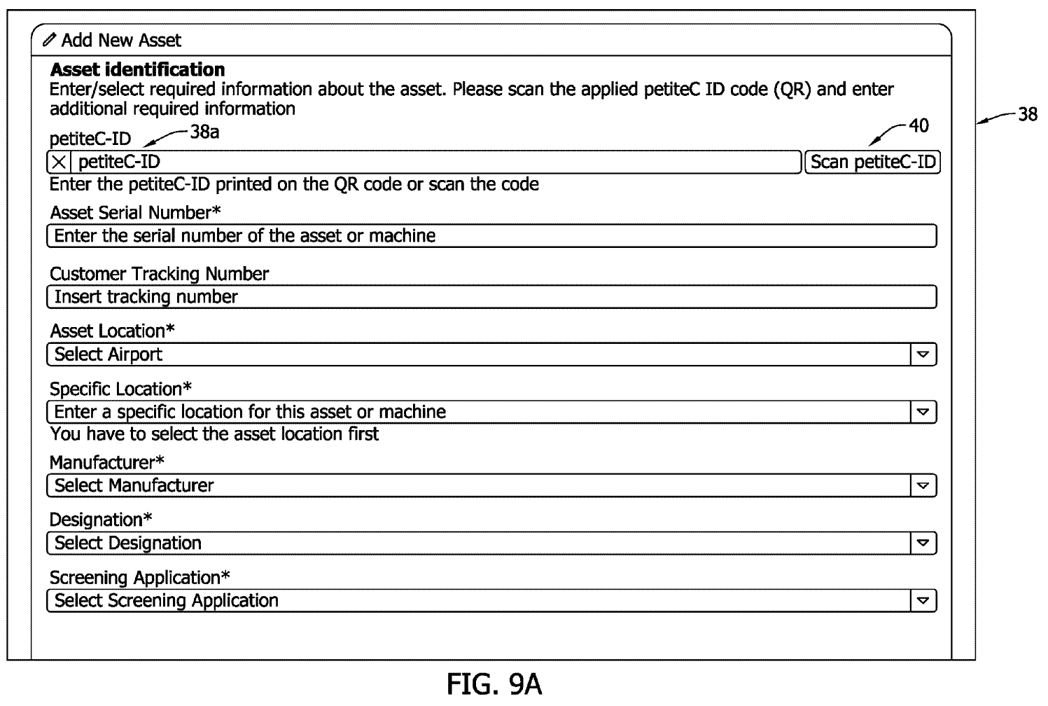

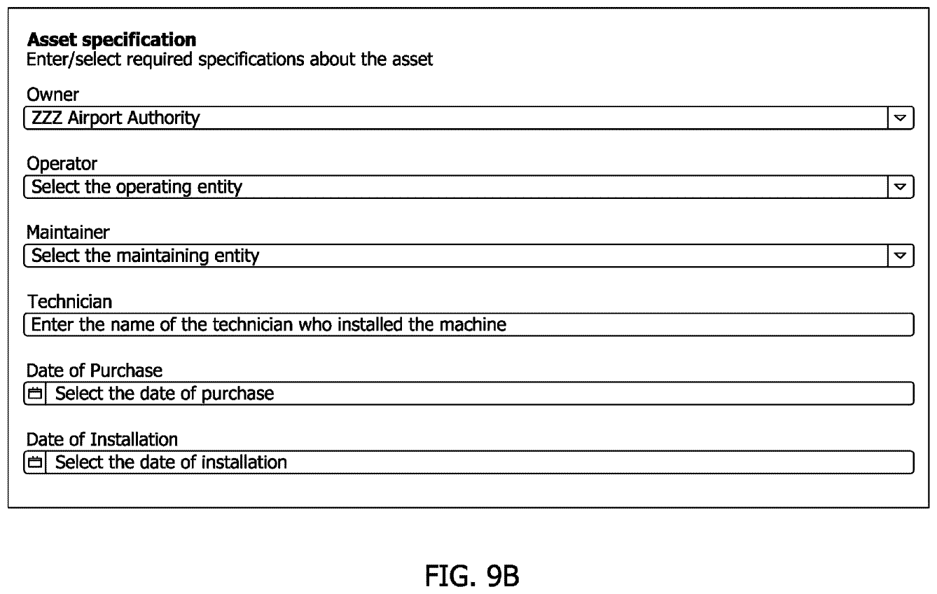

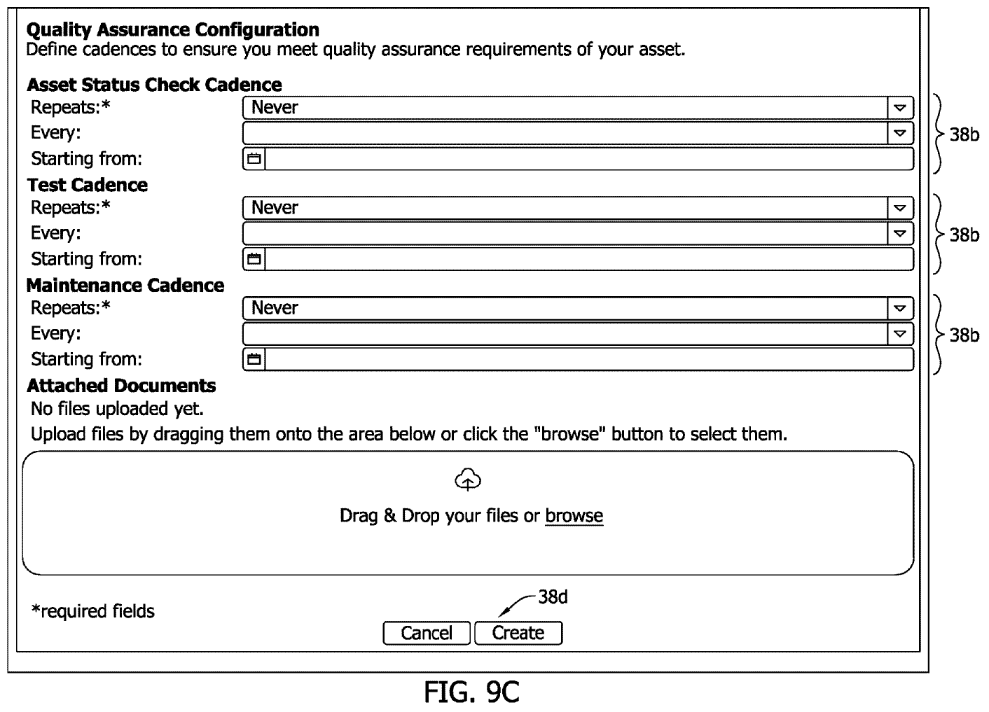

The actual onboarding of the assets starts at step S7-3 with the user linking the asset data to the asset tag to activate the asset in the asset management system 10. This is accomplished by pressing the “Add New Asset” button 24 (FIG. 8) in the menu field 20 of the User App. The user is presented with an asset identification window 38 shown illustratively in FIGS. 9A-D. At step S7-3, the user enters the unique Asset Tag identification code by either manually entering the alphanumeric ID in the ID field 38a using a keyboard or by scanning the asset tag using the “Scan ID” button 40. (FIG. 9A)

At step S7-4, set the usage category for the asset. In this step, the asset is indicated as being “active” (in which case it is available for use) or “spare” or “decommissioned” (in which case it is not available for use) and operable. After setting the usage category, the asset operability status is set. The asset can have a status of “operable” or “inoperable”. An asset can be “operable” if it is working and usable and if it does not have significant issues. For example, an asset that an overdue test or maintenance may still be operable. A specific asset can be inoperable if it is broken (i.e., it requires corrective maintenance or repair) or if the asset is out for scheduled maintenance. All combinations of usage category and operability are possible. That is, “active”, “spare”, and “decommissioned” asset can be operable or inoperable. Generally, when a new asset is on-boarded, it is assumed to be “active” and “operable”, and the on-boarding can default the assets to this combination.

At step S7-5, the user then enters the remaining information (shown in FIGS. 9A,B) for the asset. This information can be entered, for example by way of drop down lists, interactive calendars, radio buttons, a keyboard, etc. This additional information can include, for example, at least some of the following: location (i.e., the facility where it is located), specific location within the facility, the manufacturer, the model, and the screening application for which the asset is used, designation, and screening application. In addition, the user can enter information relating to the owner, operator, maintainer, technician, purchase date, and installation date. (FIGS. 9A-B) As can be appreciated, the data entered for the asset will depend in part on the type of asset being on boarded. Thus, this list is not exhaustive. Some of the information, such as location information, can be automatically entered using the capabilities of the user device. The tag (or the asset) can be provided with geospatial capabilities, in which case, the location information can be provided by the tag (or the asset).

Lastly, the quality assurance configuration is entered for the asset. As seen in FIG. 9C, here, the user enters the cadence (or schedule) for conducting status checks, tests, and maintenance. When a user enters the maintenance cadence/schedule for an asset, the user can, using the fields 38b, set how frequently the status check, testing, and maintenance are performed. To this end, the fields 38b include a “Repeats” and “every” fields which allow the user substantial leeway in configuring cadences for specific tasks. For example, cadences can be configured to require checks hourly, every 12 hours, daily, weekly, monthly, annually, etc. The quality assurance configuration also includes calendar functionality for setting a starting date for each of the status check, testing, and maintenance. The intake screen (FIG. 9C) also includes the ability to store documents (such as operating manuals, photographs of the asset, notes regarding the asset, etc.) related to the asset. This can comprise, for example, drag and drop window 38c. The user then clicks a “create”, “save”, or equivalent button 38d to transmit the data to the asset management system to be stored in the data structure.

When the user completes entering the asset data, the asset management system will, at step S7-6, determine the certification status of the asset based on the configuration and location of the asset and will provide information about vendor recommended practices and national requirements for testing of the asset and the service schedule for the asset. The asset management system may also make available to the user, via the platform, the various manuals associated with the asset and will calendar initial service, testing, and maintenance tasks based on the purchase date or installation date of the asset.

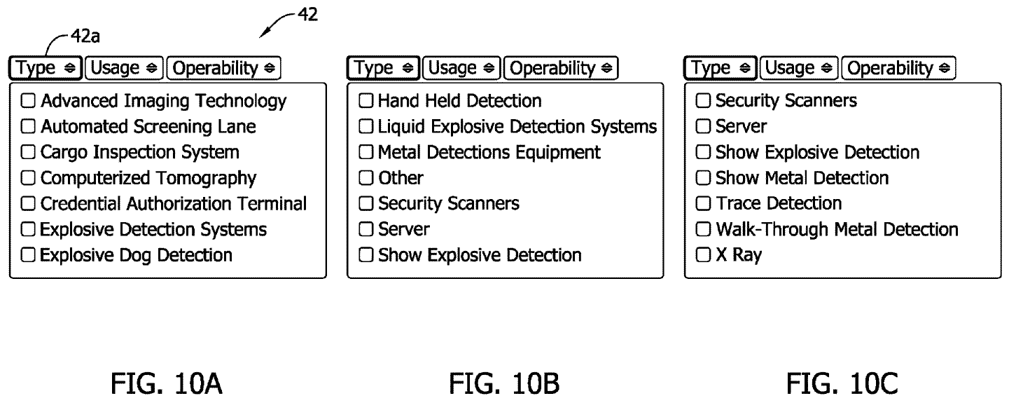

When selecting the asset type during asset onboarding, the user is provided with a drop down selection list 42 for the asset type, such as shown in FIGS. 10A-C, when the user clicks on the “type” tab 42a of the pop-up window. This list contains the homogenized type names for the asset type, enabling the user to easily select the asset type from the list, regardless of what the manufacturer might call the asset. The use of the homogenized type names allows an owner to quickly and easily see, for example, which assets are shoe explosive detectors or which are security scanners. The list of homogenized type names shown in the screen of FIGS. 10A-C is geared towards security-type assets used in airport screening. The list would be different for a different environment (such as a hospital or laboratory). Because the asset designator or model number is not typically descriptive, the typing or categorization of the asset enables a user to know quickly what type of asset a certain asset is. In an alternative method, the asset management system could automatically populate the asset type based on the manufacture make and model. The user could then override this automatic selection of the asset type if the user felt it was necessary to do so. This pop-up also allows the user to set the asset category and operability status, as described above.

Once the asset has been on-boarded, the asset will appear in the inventory list for the particular owner, as shown in FIG. 8. Any issues with the asset will be visible in the “issues” column for the asset.

Each asset record is associated with a particular set of stakeholders (i.e., owner, operator, maintainer). The asset information that each individual stakeholder can access is controlled, for example, by location of the asset and the stakeholder's function/duties. For example, a stakeholder may have access to the data for all the assets in a given facility or only assets in specific discrete locations within the facility. Alternatively, the stakeholder may have access to discrete assets at one or several locations within a facility. Thus, although the asset management system, through the various sub-data structures, will contain information regarding assets of different unrelated stakeholders, each stakeholder will only be able to view information relating to assets the stakeholder is permitted to access. This is controlled, for example, by log-in credentials. Thus, a user will not be able to view the information related to inventory with which the user is not associated. Further, the extent of information regarding any particular asset, or the ability to modify the information regarding an asset is also controlled by log-in credentials.

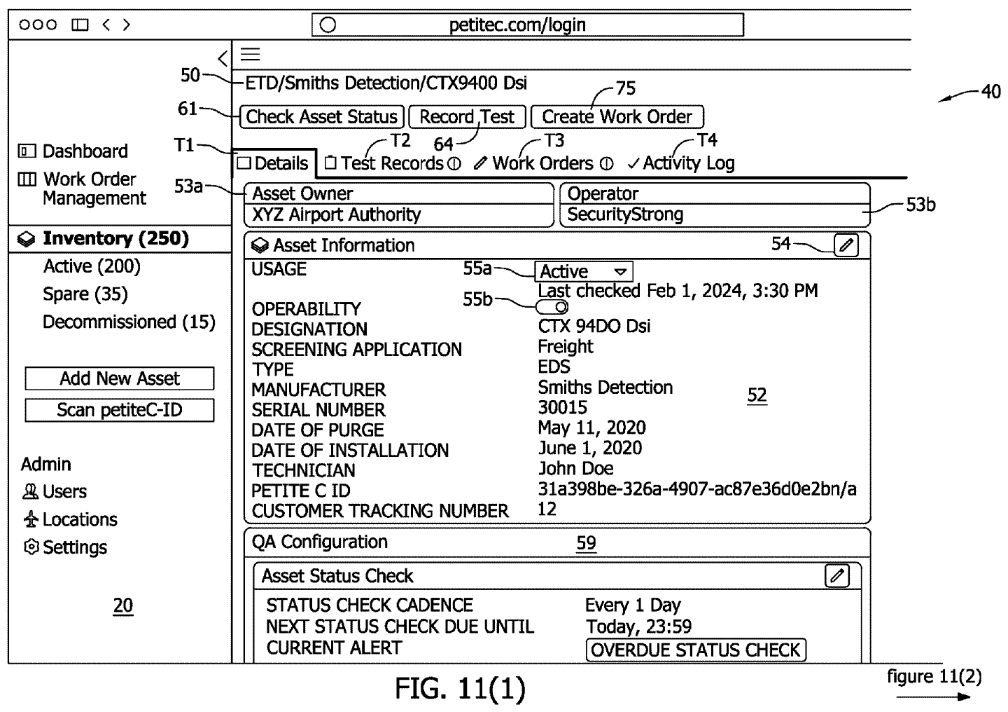

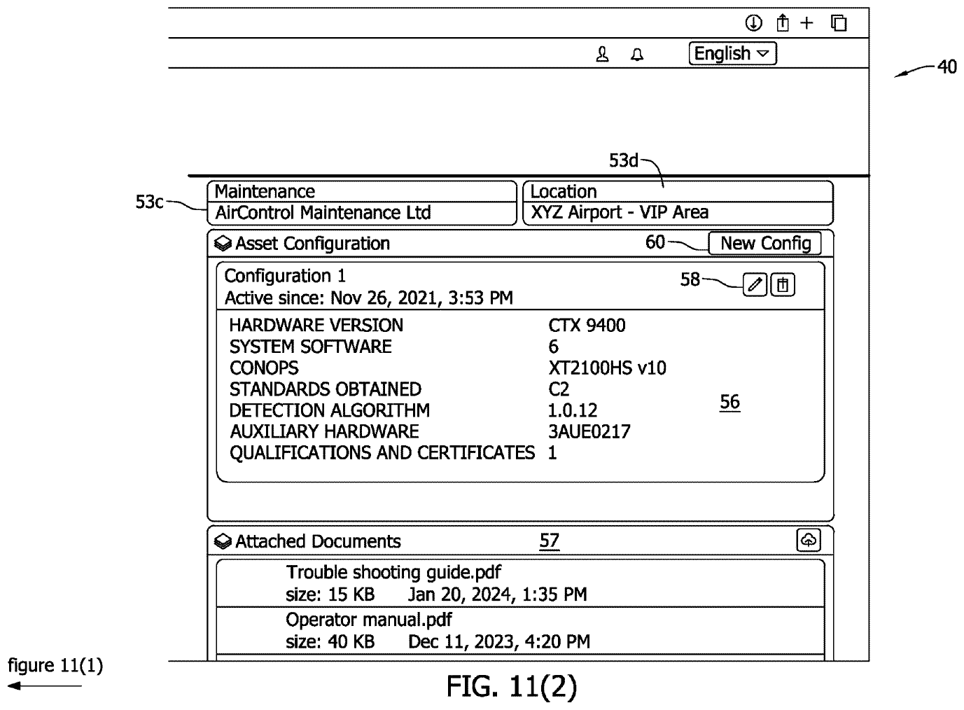

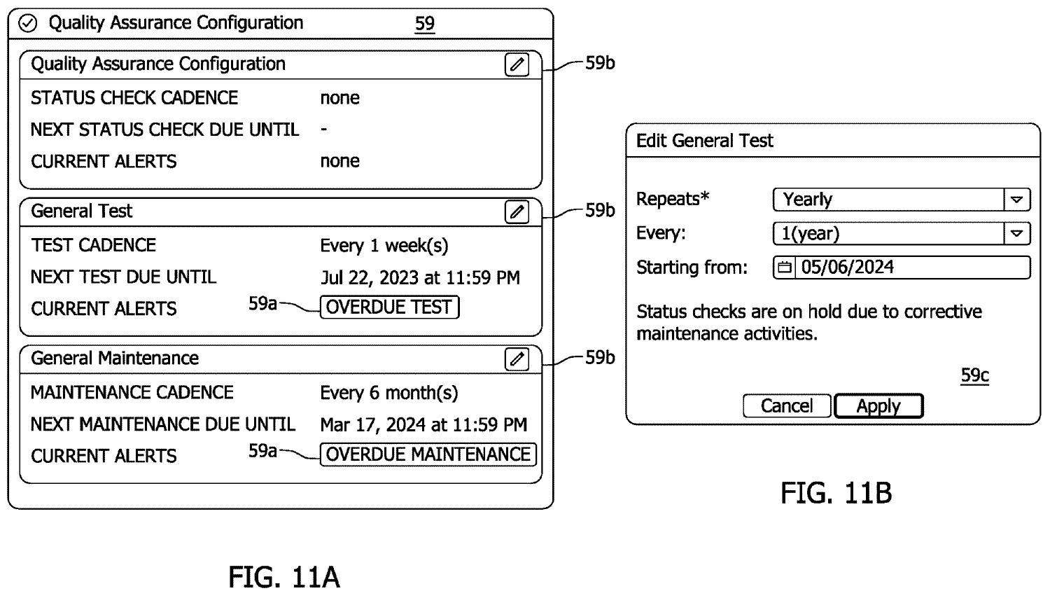

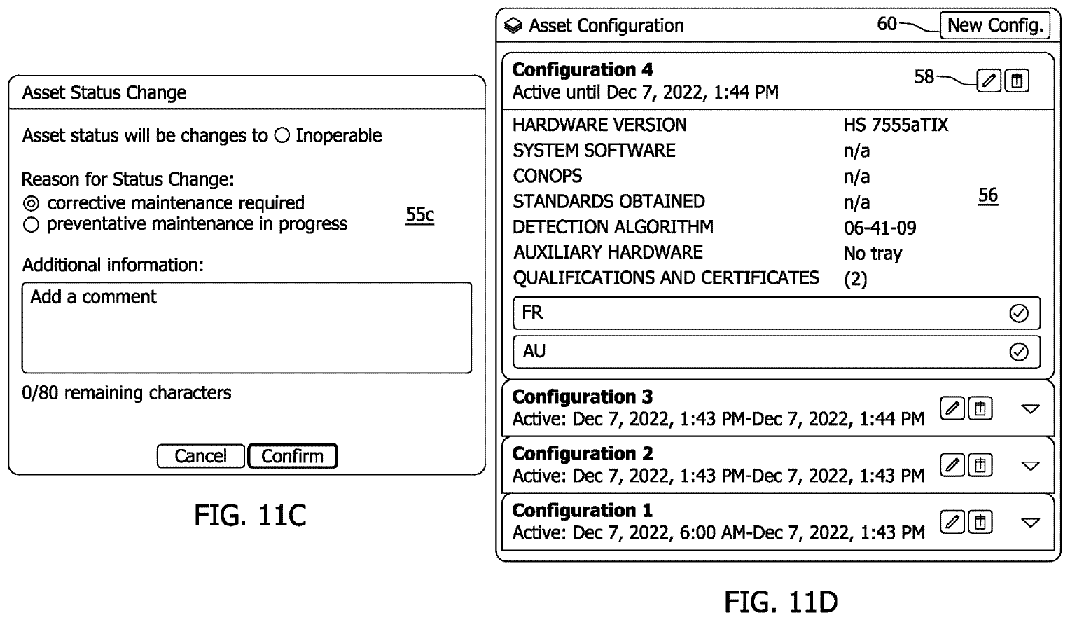

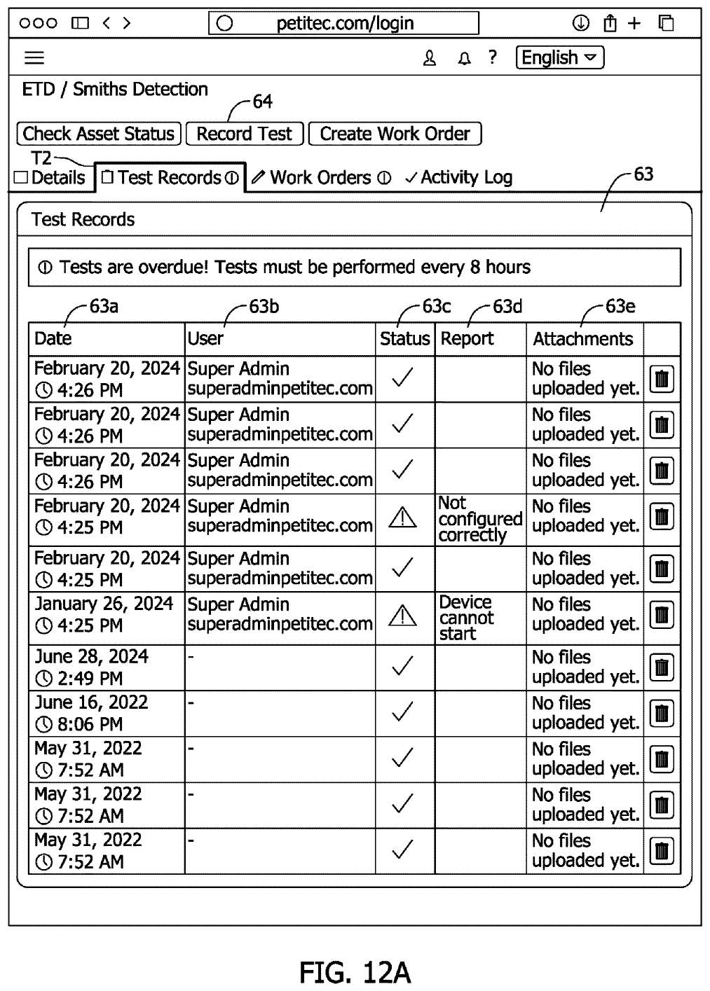

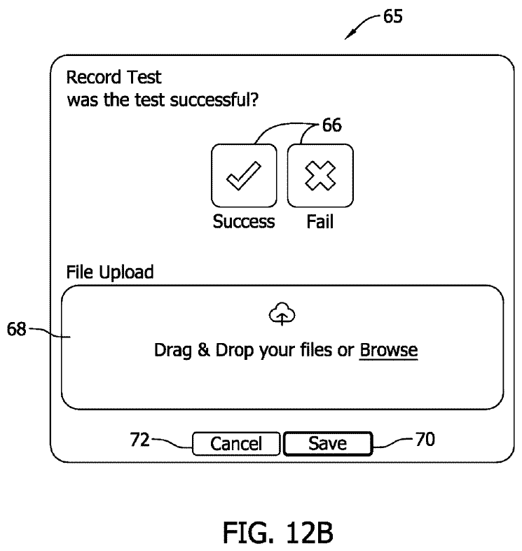

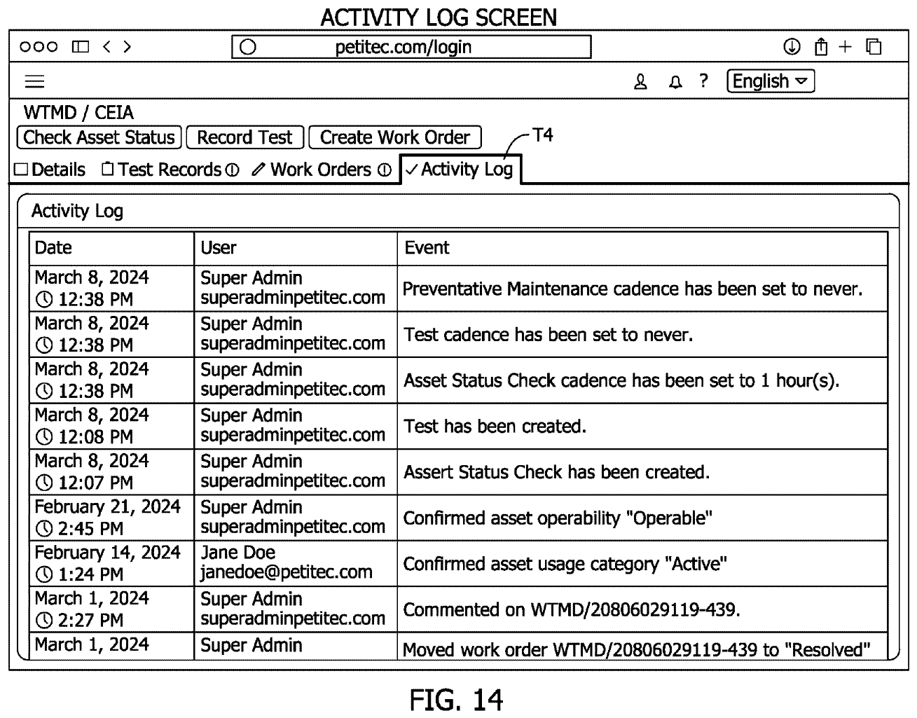

Maintenance, service, etc. of assets is accomplished via an asset information or asset detail window 49 (FIG. 11). This asset information window can be accessed by selecting the particular asset from the inventory screen (FIG. 8) or by scanning the asset tag for a particular asset. The asset information window 40 comprises four tabs: an asset details tab T1 (FIG. 11), a test records tab T2 (FIG. 12A), a work order tab T3 (FIG. 13A), and an activity log tab T4 (FIG. 14). The Asset information window screen (FIG. 11) includes a title field 50 at the top of the window which shows the asset type, asset manufacturer, and asset designation (model). Below the title field are three buttons: A “Check Asset Status” button 61, “Record Test” button 64, and a “Create Work Order” button 75. Below the three buttons 61, 64, and 75, are the four noted tabs T1-T4. The first tab T1, the asset detail tab, is the main, or landing, tab which is opened when an asset is initially selected of accessed from the inventory screen. The “asset detail tab” of the asset detail screen lists, across the top of the tab window in four tiles 53a-d, the owner, operator, maintenance company, and location of the asset. Below that, on the left side of the tab is an “asset information” tile 52, which at its top shows the current usage category 55a (active, spare, or decommissioned) for the asset. The current usage category can be color coded so that its status is quickly and easily determined. For example, the usage category can be grey if spare or decommissioned and green or blue if active. Below the usage category, asset information tile includes an operability selector button 55b which can be used to manually switch the asset's status between operable and inoperable. The background for the selector switch can be color coded. For example, the background can be red if the asset status is inoperable and blue or green if the asset status is operable. If the asset status button is moved from operable to inoperable, the asset management system will display the pop-up 55c shown in FIG. 11C which includes a pair of radio buttons for the operator to note that the status change is due to the fact that (a) corrective maintenance is required or (b) that preventative maintenance is in progress. The pop-up also includes a text box where the user can add notes in a free-form manner using an input device, such as a stylus or keyboard. By pressing the “Confirm” button, the status for the asset will be changed to “inoperable”. The status can then be returned back to “operable” when the corrective maintenance or preventive maintenance is complete. Returning to FIG. 11, the asset information tile 52 displays basic information regarding the asset, including its designation (model), screening application (if applicable), type, manufacturer, serial number, purchase date, installation date, technician and asset tag identification code. As can be appreciated, the data included in this asset information window of the asset detail tab will vary depending on the type of asset. At the top right, the asset information tile 52 includes an “edit” button 54 in the form of a pencil icon. Clicking on the edit icon 54 will take the user to the asset identification window of FIGS. 9A-D (albeit to edit asset information rather than to input information regarding a new asset). This will allow the user to update changes relevant to the equipment, such as location, owner, operator, maintainer, technician, etc.

An “Asset Configuration” tile 56 is next to the Asset Information tile 52. The Asset Configuration tile, shown in more detail in FIG. 11D, can include the following information, when applicable: hardware version, the software version, CONOPS (concept of operations), standards, detection algorithm, auxiliary hardware, and qualifications and certificates. As can be appreciated, the information regarding configurations can vary depending on the type of asset. Edit and delete buttons 58 in the form of pencil and trash can icons, respectively, are located at the top right of the configuration tile 56. Pressing the edit icon will allow the user to edit the configuration information, for example if the software has been updated or the detection algorithm has changed. Additionally, the asset management system can have more then one configuration for a particular asset. As seen in FIG. 11D, the particular asset has 4 configurations (one of which is expanded to show the configuration information, and the remaining three being collapsed with only a title and minimal information displayed. The information for the collapsed configurations can be expanded viewed by clicking on a selected configuration. The ability to store different configurations can enable the same asset to quickly be altered to change its operability. For example the configuration of a scanner could be selected to detect different types of items of concern (e.g., soft items, liquids, gels, or hard items). The configuration of the asset can be changed simply by clicking on the selected configuration. Further, new configurations can be added by clicking the “New Config” button 60 at the top of the window 56. Configurations which are no longer used can be deleted by pressing the “delete” icon. The asset management system can include an “Are you sure?” prompt to avoid accidental deletion of a configuration of the asset.

Below the asset information tile 54, the asset detail screen 49 includes a quality assurance configuration tile 59, which is shown in enlarged in FIG. 11A. The quality configuration tile displays the cadence/schedule for the status check, testing, and maintenance for the asset. It also shows when the next status check, test, or maintenance is due; and if any are overdue, an overdue message 59a will appear below the overdue activity. Preferably, the message will be highlighted (for example in red) so that the overdue status will stand out. The cadences for any of the status check, general test, and general maintenance can be edited by selecting and clicking on the respective edit button 59b. Clicking the edit button brings up the pop-up window 59c, such as shown in FIG. 11B, which illustratively shows the status check editing feature. Editing the cadence will be identical to entering cadences as described above. The edited/revised cadence can then be accepted by clicking an “apply” button the bottom of the window. It will be appreciated that the pop-up windows for editing the testing cadence and maintenance cadence are the same.

Adjacent the quality configuration tile is a document tile 57 which contains files or documents relevant to the particular asset. These documents can include, for example, operating manuals, troubleshooting guides, etc. Clicking on a selected document will open the document for review. Although not shown, the document tile 57 can include drag and drop capabilities to add documents to the tile. Alternatively, documents can be added via a “browse” function by clicking on “browse”. Such files can include documents can include items such as operating manuals, trouble shooting guides, warranty information, photographs of the asset, notes regarding installation, etc. Additionally, the files can include text files, pdf's, image files, photographs, etc. related to the asset.

Finally, if the asset is sold, disposed of, or is no longer in the possession of the owner, the asset detail screen can include a “Delete Asset” button (not shown) which can be clicked to remove the particular asset from the inventory list. The asset management system can prompt the user to ensure that they intend to delete the asset to avoid inadvertent deletion of the asset. The ability to add, modify, and delete configurations, and to delete an asset can be privilege based, so that only specific users can carry out these functions.

Typically, assets must be tested/calibrated on a regular basis. The test record tab T2 is shown in FIG. 12A. As seen, the test record tab includes a test records panel 63 which comprises a table listing a history of tests performed on the asset. The table includes columns 63a-e showing, for each test, the date the test was performed, the technician who performed the test, the test results (success/fail), a report, and any uploaded documents. The test results can be shown graphically, such as with a check mark when the test is passed or a warning indicator (such as “A”) for a failed test. Further, the indicators can be color coded-green for a passed test and red for a failed test. Although not shown, the record test table can also include a column to show the type of test that was run. To run a test, the “Record Test” button 64 is clicked which brings up the pop-up 65 shown in FIG. 12B. This pop-up 65 will also be presented using the “Record Test” button at the top of the asset details screen. (FIG. 11) The technician runs the necessary test and, based on the test results, clicks the “Success” or “Fail” button 66 depending on the test result to record the test result. The technician can then upload any files relevant to the test by dragging and dropping files into the drag and drop file upload area 68. Alternatively, the user can upload files via a “browse” function by clicking on “browse”. These files can include text files, images, or any other file type that the user deems relevant to the test result. Once complete, the user presses the “save” button 70 in the “record test” pop-up window. If the user needs to start over, or otherwise cancel the test, the user can press the “cancel” button 72. Once the test results are saved, the asset management system will populate the test history panel 63 (FIG. 12A) with the test results. The test “date” will be the date the test was performed, the user field is populated based on the log in credentials associated with the user who ran the test. The asset management system does not communicate directly with the asset, and thus does not receive the test results directly from the asset. Thus, the user must run the test, and then enter the test results into the asset management system. Although not shown, the “Record Test” screen of FIG. 12A could be provided with a text box in which the service technician can enter free form comments regarding the test. Such text could be entered using a keyboard, a voice recording, or dictation (which is automatically transcribed by the asset management system).

It can be important to authenticate that the user was actually at the asset during the testing. Confirming the location of the user during testing to ensure that the user is at the asset can be accomplished, for example, by using the GPS functionality of the user's User Device UD. For example, when the user initiates a routine test, the asset management system can query the user device UD for its location when the “Record Test” pop-up (FIG. 12B) is activated. The user's location can then be compared to the known exact location of the asset being tested. If the asset management system determines that the user is not at the asset (or within a predetermined distance of the asset), the asset management system could place a note in the file for the particular asset and require either a subsequent check (i.e., a retest) of the asset or an explanation as to why the user was not at the asset when running the test.

As noted above, all assets have a regular testing and maintenance schedule. Maintenance is conducted periodically according to a determined schedule and is automatically calendared by the asset management system, as set by the quality assurance cadences. Testing, on the other hand, is performed more frequently, and is to be conducted within a determined time period, also as set by the quality assurance cadences. Upon completion of routine maintenance, the asset management system will reset the maintenance calendar for the asset, and a new maintenance date will then be entered in the asset management system using the date the maintenance was performed as a base date. Thus, if maintenance is to be performed every three months, the next maintenance will be scheduled for 3 months from the date maintenance is performed. Because testing/calibrating is more frequent, it is not necessarily calendared, per se. Rather, testing/calibrating can be set to occur, for example, daily, weekly, etc. If a test is failed, the asset management system will alert the user to this fact on the inventory screen in the “issues” column.

The calendaring of maintenance and the setting of a testing cadence/schedule (whether calendared or not) provides for a compliance clock. There can be multiple testing/calibrating and maintenance calendars or clocks for a single asset if there are multiple tests/calibrations or different maintenance tasks that need to be performed for that asset—especially if the various tests/calibrations or maintenance tasks are performed at different intervals. The testing/calibrating and maintenance schedules can be set during onboarding of the asset (and edited subsequent to onboarding if necessary). Testing/calibrating is to be performed during the relevant period. Thus, for example, if an asset is to be tested on a weekly basis, it could be tested at the end of one week. The asset management system would note that the test has been performed, with the next cycle starting the beginning of the next week (which could be the next day). Conversely, an asset on a weekly testing schedule could be tested at the beginning of one week, and the next test could be performed toward the end of the following week. Because both tests would be performed during their relevant period (i.e., during the respective weeks), the test cycles will be deemed to have been satisfied. Thus, the testing/calibrating cycle is dependent on the cycle, and not when the testing/calibrating was performed during the cycle. The maintenance calendar, on the other hand, is based on the date maintenance was performed. If, for example, an asset requires maintenance every three months, the next maintenance will be calendared for three months after maintenance has been performed. The testing/calibrating clock will be deactivated if an asset is tagged as being inoperable or out for maintenance, and the testing/calibrating clock will be reinitiated when the asset is returned to operating status. Conversely, the maintenance clock may continue to require maintenance for an asset that is tagged as inoperable. This would depend on the reason for the asset being inoperable. Further, if an asset is a spare, it may be necessary to conduct routine maintenance on the asset to ensure that it is in proper order if the asset is returned to active status. If, according to the compliance clock, testing/calibrating or maintenance is overdue, this can be displayed in the quality assurance configuration tile 59 in the asset detail window 52 on the asset details screen. (FIG. 11) As noted, this tile can also indicate when the asset is scheduled to receive its next regular maintenance, testing, or calibration. This can be in the asset status field, or it could be in a field not shown in FIG. 11.

Maintenance/repair (as compared to regularly scheduled servicing and testing) is tracked on the “Work Orders” tab T3. (FIG. 13A) The Work Order screen is effectively divided into two parts. An upper part 73a is divided into four columns 73a1-4 of maintenance tasks “to do”, “in progress”, “resolved”, and “closed”. Adjacent each column title, the screen displays the number of tasks in each column. Above the columns, the work order tab includes a search bar and preset filters which enable a user to show maintenance tasks that satisfy certain parameters as set by the search bar or filter. Inside of each column, the upper portion 73a includes a tiles 74 which show the various tasks in the various columns. If the column includes more tasks than shown, the user can scroll through the column to view the other tasks. Each maintenance tile 74 in the “to do” and “in progress” columns includes a vertical ellipse 74a which when clicked give the user move the task. For example, in the “to do” column, the user is given the option to (1) move the task to “in progress”, (2) move the task to “resolved”, (3) close the task, or (4) delete the task. The vertical ellipses in the tiles in the “in progress” are similar, but only include options to resolve, close, or delete the task. A task is “resolved” if the issue is corrected. When the task is resolved, the asset status can be moved from “inoperable” to “operable”. A task is closed when for some reason, the task cannot be readily resolved. For example, if a needed part is no longer available.

The lower portion 73b of the Work Order screen comprises a work order records table which lists a history of both preventive and corrective maintenance performed on the asset. It will be understood that “preventive maintenance” includes scheduled tasks, such as calibrations, testings, cleanings, etc. “Corrective maintenance” on the other hand refers to tasks generated in response to something that has gone wrong with, or is broken on, the asset. The work order records table is automatically populated from the tasks in the resolved and closed columns of the upper portion 73a. Resolved and closed tasks initially remain in the upper portion 73a and are moved to the work order records table in the lower portion 73b thirty days after a task is moved to the resolved or closed column. The work order records table includes five columns 73b1-73b5. Column 73b1 lists the work order number. Column 73b2 lists the title provided for the work order. As seen, preventative maintenance tasks are listed as such, but non-routine tasks (i.e., corrective maintenance tasks) are provided a short title. In addition, the preventative and corrective maintenance tasks are provided with representative icons. Column 73b3 lists the assignee assigned to perform the task. The assignee can be an individual, a team, or a maintenance company. The person, team, or entity assigned to a task will depend on the task required. Column 73b4 lists the processing time, i.e., the time taken to resolve (or close) the task. Lastly, column 73b5 lists the date the task was completed (resolved or closed) and provides an icon indicative of the result. A check mark can be provided for tasks that were successfully resolved; and a warning symbol (e.g., “/”) can be provided for tasks that could not be successfully resolved.

When corrective maintenance is required for a particular asset, the user will navigate to the asset detail screen for the particular asset by either selecting the asset from the inventory list or by scanning the asset's Asset Tag. In the asset detail screen, the user will click on the “Create Work Order” button 75. The “Create Work Order” button is also available in the “Work Order Management” screen (FIG. 13B). Clicking the “Create Work Order” button 75 will bring up the “Create Work Order” pop-up 76 (FIG. 13D). The top portion 76a of the work order includes information regarding the asset, such as the asset's type, status, unique ID number, serial number, location, and manufacturer. This information is preferably autopopulated based on the information in the asset detail screen. Below that, a selectors 76b-d (for example in the form of drop down boxes) to select the type of work (i.e., corrective or preventative maintenance), the priority (low, medium, or high), and the assignee for the work order. Below the “assignee” selector, the work order menu 76 includes date selectors 76e,f to provide a start date and a due date for the task. If the task is a high priority task, the start date can be automatically set to the current date. A title and description for the task can be provided in text boxes 76g,h. As can be appreciated, the title will be a short title, and more detail regarding the issue requiring the issuance of the task can be provided in the description box 76h. Any attachments (such as photographs or documents that may be relevant to the issue can be loaded into the attachment box 76i. The upload of documents can be accomplished via drag-and-drop or browse-and-select functionality. When all the data has been entered, the user can click the “Create” button. The “Create Word Order” pop up also includes Ticket ID and Ticket link fields 76j,k which are filled in by the which provide integration of the asset management system 10 with third party tools. Upon hitting the “Create” button, the asset management system will place a tile for the task in the “to do” column of the work order management screen (FIGS. 13A,B) If for some reason the ticket is not required, the user can click the “cancel” button.

Work order tickets for preventive maintenance are automatically generated based on the cadences for the various preventative maintenance tasks. In this instance, the title can be autopopulate with simply “preventative maintenance,” as seen in FIG. 13C, or it can be populated with a title for the preventative maintenance, such as “change filter”. The start and due dates for the preventative tasks will be set based on the cadences that were previously set.

Unscheduled maintenance or service will be conducted when there is an issue with an asset. Such unscheduled maintenance or repair can be required due to a failure to pass routine servicing or testing, or by a failure of a part of the asset.

Upon generation of a work order, and in particular, of a corrective maintenance work order, the asset management system will send a notice/communication to the necessary stakeholders. Thus, a notice can be sent to the assignee, the owner, and the operator. The notice can be sent, for example, via email, SMS message, voice message. This message is preferably issued immediately upon generation of the work order. This way, all necessary stake holders will immediately be informed of an issue with an asset and can plan as may be necessary to resolve the situation generated by the potentially inoperable asset.

When a particular work order is acted on, the user will click on the work order and conduct the maintenance noted in the work order. Clicking on the work order will bring up a pop-up similar to the “Record Test” pop-up of FIG. 12B. Initially, clicking on the work order will move the work order from the “to do” column to the “in progress” column. Using the Work Maintenance pop-up, the user can indicate whether or not the noted maintenance was successfully completed and can add files (documents, photographs, etc.) as desired to include with the maintenance record. A successful completion of the maintenance will move the noted work order to the “resolved” column. If the word order is not completed successfully, it can remain in the “in progress” column or be moved to the “closed” column depending on the reason for the inability to successfully complete the maintenance.

On occasion, the manufacturer may become aware of an issue with the asset that needs attention. In this case, the manufacturer will notify the asset management system of the maintenance that needs to be performed on particular assets. The manufacturer will provide the asset management system with at least the make and model of the asset affected, a description of the work that is required, and any documents relevant to the required maintenance/repair/upgrade. The manufacturer can accomplish this, for example, by using a manufacturer portal through which the manufacturer can make available to the asset management system any information (including updated documentation regarding assets) to the users of the asset management system. When the manufacturer enters this new information regarding the particular asset, the “asset common information” table for the particular asset is updated with the new information, and the asset management system automatically distributes the information (whether it be new documentation, new procedures, required unscheduled maintenance/repair work), such that the inventory table for each user reflects the notice in the “issues” column of the inventory screen for the asset. The change in status can appear in the asset status field of the asset detail screen (FIG. 11). Alternatively, the stakeholder can be notified of the change via in-app messaging or via email.

All activity related to the particular asset will be shown on the “activity log” tab (FIG. 14). This tab presents a table listing the date an event occurred, the user that performed the event, and a brief description regarding the event. These events include activities such as testing/calibrating, maintenance/repair, creation of new configurations, change in location, etc. Thus, the full history of the asset will be visible on this screen. Individual events can be selected to obtain more information regarding a selected event for the asset.

Lastly, the asset management system can allow any one of the stakeholders to pull data of an asset (during servicing or at regular intervals separately) related to performance. The performance data can include information such as: throughput, alarm rates, false alarm rates, bags per image for x-rays, etc. Obviously, the specific performance data would vary depending on the type of asset. Given the systems are not networked, today users walk around with clip boards and write this stuff down on pen and paper. By enabling the system to capture this performance data, users will not need to write down and then record the information. Rather, the relevant performance data for a particular asset could be entered during scheduled testing.

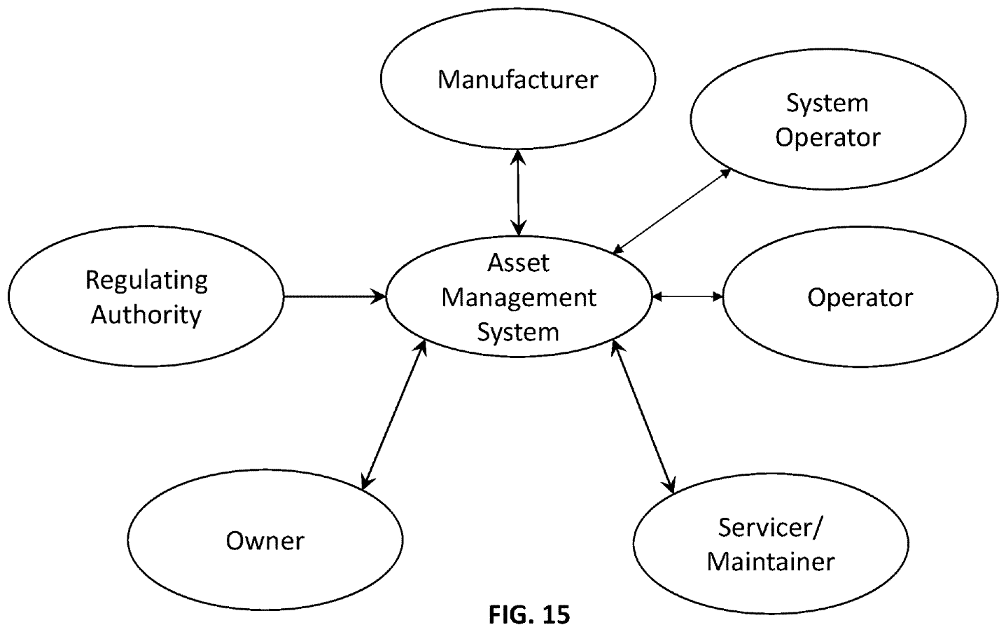

As can be understood from the foregoing, the asset management system provides for an electronic log for all assets of an owner/operator. The asset management system also creates a communication channel, as shown graphically in FIG. 15, between the owner (or user) and the manufacturer. As noted, the manufacturer, through a manufacturer portal, provide can updated information to the owners/operators/maintainers through the asset management system, and the availability of such new information will be evident from the “issues” column 37 of the asset inventory screen. (FIG. 8) As noted above, such new information can include required maintenance or new documentation for a particular asset model. This information can also relate to updated software or firmware for the asset or any other information related to the particular asset model. When such new information is provided by the manufacturer, the record for the asset is updated, as noted, and the user's inventory screen will include an indication in the “issues” column indicating that there is new information regarding the particular asset. The user can then open up the asset data screen for the asset and determine what actions need to be taken with respect to the particular asset. This could include a repair, a software upgrade, etc. When such a notice of a required action is entered into the asset management system by a manufacturer, the asset management system will recognize it as such, and will generate appropriate work orders for the relevant asset of each affected user. Thus, for example, if a manufacturer of a scanner pushes through a new driver for the scanner, a new task will be entered for every owner of such a scanner.

Similarly, information can flow back to the manufacturer from the user. For example, the results from regularly scheduled testing and calibration results from the users of the assets can be aggregated. This aggregated information related to a specific asset model may give the manufacturer an early indication that a specific calibration test or a specific servicing is routinely failing—or failing more frequently than expected—and is failing with respect to multiple users. When presented with this information, the manufacturer may be able to determine what the issue is and provide updated information or fixes for the issue. The ability to provide early warning to the manufacturer gives the manufacturer the ability to address the issue at an early stage, and the other owners can take the affected asset offline with the knowledge that there may be an issue with the asset.

As also seen in FIG. 15, information from the regulating authority is delivered to the asset management system. This information can come directly from the regulating authority via a regulating authority portal, or from the System Operator. Such information includes items such as assets certified for use in the regulating authority's jurisdiction, rules and regulations relating to certification in the jurisdiction, etc.

The communication between the manufacturer or its designated representative and user is not direct, one-to-one communication. That is, the asset management system does not provide a communication path for a particular owner to communicate directly with a particular manufacturer/representative. However, this could be provided for if desired.

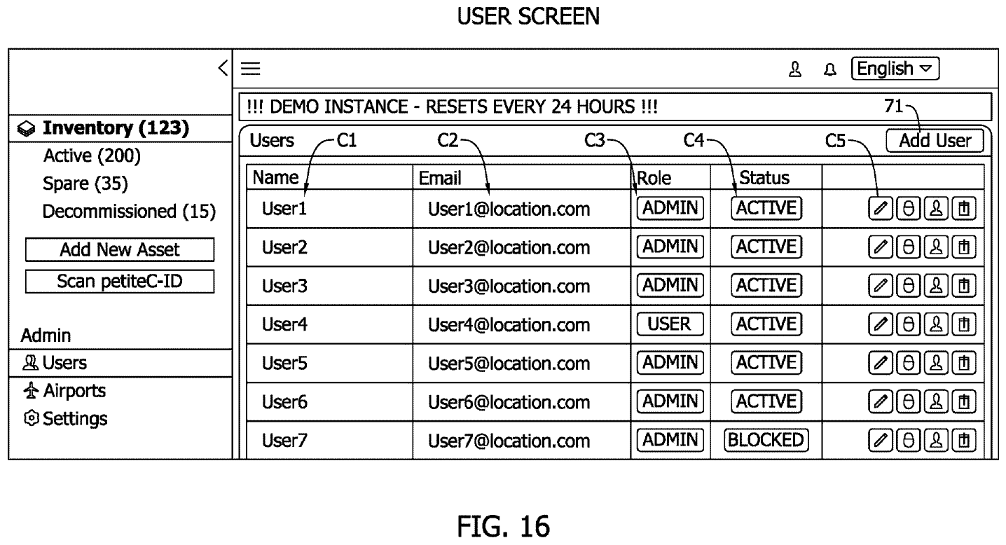

The administrative portion 28 (FIG. 8) of the of the menu field 20 enables administrative personnel to perform administrative tasks in the asset management system. FIG. 16 shows a user screen which provides an illustrative list of users that can use the asset management system. The table of FIG. 16 provides, for each user, the username C1, the user's email address C2, the user's role C3 (i.e., administrative or user), and the user's status (e.g., active, invited, blocked) C4. As can be appreciated, a user with “Admin” rights can make changes to the asset management system, including adding assets, deleting assets, modifying asset records, adding, modifying or deleting asset configurations, adding users, etc. A user with “User” rights can see the data, and to enter information regarding servicing, testing, maintenance, and reports regarding the assets. To the right, the table includes a column C5 which provides a series of icons adjacent each user, which enable the user information to be edited (pencil icon), the user to be given user rights (the lock icon) or administrative rights (the person icon) and to delete the record related to the particular person (the trash icon). To add a new user, the “add user” button 71 at the top of the screen is pressed. This will bring up a screen (not shown) in which user information can be added. This user information includes information such as name, email address, location where user works, user role (i.e., admin, manager, use, viewer, etc.), login credentials (such as a login name and password, or badge ID code) and system rights (user rights or administrative rights).

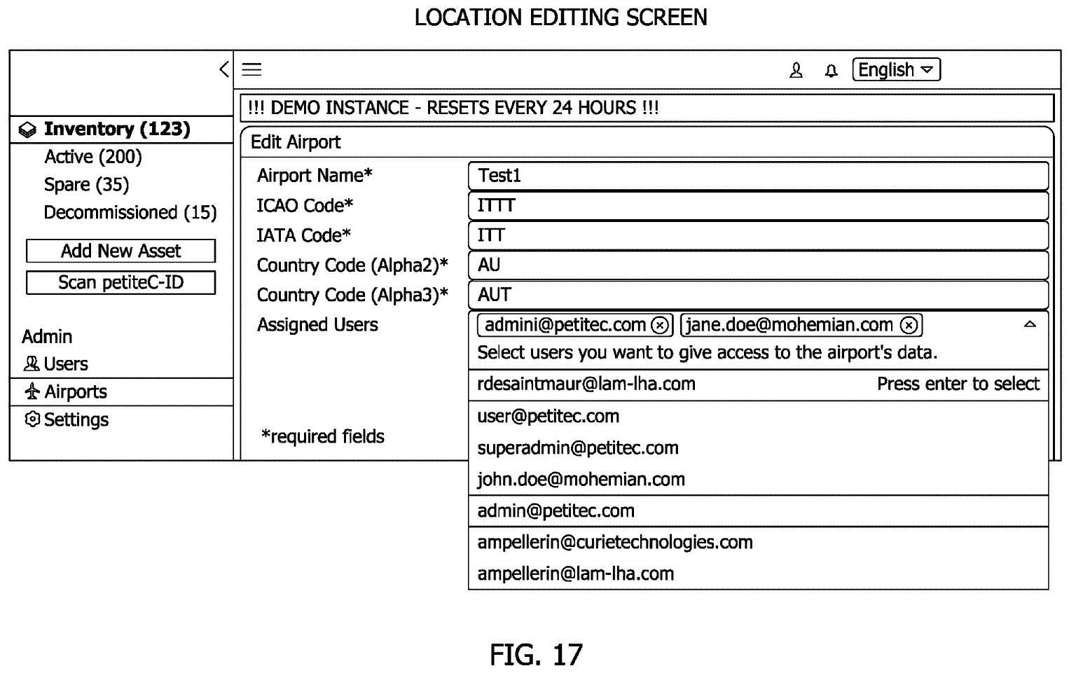

Clicking on the “airports” (or location) button in the menu field will bring up an airport (location) information screen, shown in FIG. 17. With respect to an airport, this screen includes information such as the airport name, its ICAO and IAA code, the two and three letter codes for the country in which the airport is located. If non-standard codes are to be provided for the locations, then non-standard names or codes can be included here as well. The location information would vary depending on the type of location. Additionally, the location editing screen includes a drop down list which enables an administrator to associate particular individuals, users, or stakeholders with the particular location. As can be appreciated, if an asset owner has assets at, for example, two airports, and if a user is associated with only one of the airports, the user will not be able to enter information related to assets at the other airport, and thus will be precluded from servicing, testing, calibration, and maintaining or repairing assets at the other airport. As noted above, the asset management system is described for use with airports. If used in a different type of facility, the “airport” button could be replaced with a “[location]” button, where “[location]” is replaced with the type of location (i.e., federal facilities, national laboratories, nuclear security facility, etc.).

As noted above, an email address is associated with each user, the asset management system can generate a periodic email alerts to the users for assets in locations with which they are associated. These alerts can include information such as required testing, overdue testing, upcoming required maintenance, incomplete maintenance or repair, etc. The various uses can also receive emails, for example, when the status changes for an asset or if a work order is entered for an asset. The system thus enables stakeholders to keep abreast of the status of the assets in practically real time, and thus helps with monitoring the status of the assets.

For security reasons, a company, such as an airline, does not want to allow vendors, suppliers, or manufacturers to access their network. At the same time, the company might not want asset data in aggregate to exist outside of their network (i.e., with their vendors/suppliers). The platform, as described above, can overcome these concerns, and build a vendor community outside customer networks (to protect them) and allow these stakeholders to use the asset management system/load data in a way that will allow the company to use pull analytics, while protecting the company's core aggregated asset data. To facilitate this, and to promote acceptance of the platform:
The overarching data structure, as described in conjunction with FIGS. 3B,C, comprises separate and discrete sub-data structures associated with each customer or stakeholder of the asset management system. Each sub-data structure comprises only a portion of the data for an asset, such that the data for an asset is spread among multiple discrete sub-data structures. When a user requests to view data for an asset, the User App will issue an inquiry to the computer system which will then access the relevant data from the discrete sub-data structures and will combine display the data for the asset in the various screens of the User App, as described above. Importantly, no customer or stakeholder will directly access the sub-data structure for any other customer or stakeholder. This will make it more difficult for third parties to access complete information regarding an asset.
The system operator can set up an instance of, at a minimum, the data structure for the company and onboard all of its assets. Preferably, this instance is cloud-based outside the company's network). The company will provide full list of service providers.
The company sends an email to all of their operator/maintainer/manufacturer partners asking that they register as a partner with the system operator.
Operator's/maintainer's/manufacturer's partners register on a partner portal of the platform and provide a “code” provided by the company or the system operator which connects the partners in the platform with the company's instance/requirements, and thus the company's assets.
The partners register their businesses and provide the usernames as prompted.
The system operator sets up user accounts for the various partners which are linked to the company's instance. Any one of the partners could thereafter be linked to instances of other companies.
These users/partners then have the ability to scan tags for the company's assets for which they are registered and push data through the portal related to those assets. The users/partners will also have limited view on compliance through the portal;
The company can see the data generated by the partners for its assets on an aggregated basis and with a greater amount of information around each asset than currently possible;
Manufacturers which registered with the portal via a manufacturer portal could add more information regarding their assets thereby providing the company and the partners increased access to information regarding their assets.

This approach helps the company offload the setting up/training all of the vendors/partners and mitigates risk for them as the venders/partners would not have access to the company's own network or to aggregated data on their assets.

As can be appreciated, the asset management system/platform described herein provides a unique and improved asset management system for monitoring, servicing, and maintaining assets. In particular, the asset management system provides for an electronic work log for each asset in a facility, and provides a communication channel between owners, operators, maintainers, and manufacturers which enable information to flow more freely between the stakeholders. As described above, this flow of communication can provide a manufacturer early notice that there may be an issue with a particular model, enabling the manufacturer to provide an alert to other users and to create a fix to the issue at an earlier date that would have been possible without such a communication channel.

Additionally, in environments, such as an airport, where there is an entity (such as the airport) which is not an owner, manufacturer, service provider, or operator, but yet has a need to know the status of the assets, the asset management platform/system enables the entity to stay informed. In the instance of an airport, the asset management system automates, in real time, the phone tree approach typically used to notify relevant stakeholders of broken assets and ensures they have relevant status information at every step in the process, including when the tech is repaired and back in operation. This enables better resource allocation for both the regulating authority and airport personnel alike. In addition, the asset management system enables the regulating authority and airport stakeholders to share relevant airport-wide security asset data for enhanced planning and upgrade activities.

As various changes could be made in the above constructions without departing from the scope of the invention, it is intended that all matter contained in the above description or shown in the accompanying drawings shall be interpreted as illustrative and not in a limiting sense. For example, although the asset management system is described for use in an airport, it would have applications in other facilities, such as hospitals, which have assets which must be monitored, tested, and maintained. Any message that is sent via email could additionally, or in the alternative, be sent via SMS messaging, or other electronic messaging formats. These examples are merely illustrative.

1. An asset management system for managing physical assets, the asset management system comprising a communication module and a processor, said processor being adapted to execute computer program instructions stored in a non-transitory memory and operative to cause the processor to store, in a memory coupled with the processor, a data structure comprising asset data for a plurality of assets;
wherein said asset data comprises:
i) for each asset, a unique universal identification code and one or more of an asset type, asset identification information, asset configuration information, other unique IDs used by manufacturer, maintainer, operator, or owners, and asset activity history information; and
ii) an asset type for each asset; said asset type being selected from a harmonization table stored in said memory, the harmonization table providing a concordance between a determined list of types of assets and names for the asset provided by manufacturers and/or asset certifying authorities, wherein the asset type for each asset is selected from the asset harmonization table;
wherein said data structure system is configured to:
enable users to add assets to the asset management system;
enable users to enter into said asset management system activity history information data regarding status, testing, calibration, maintenance and/or servicing of said assets; and
enable users to confirm or alter the status of each asset, in particular whether the asset is operable or inoperable.

2. The asset management system of claim 1 wherein said data structure comprises a plurality of distinct and separate sub-data structures, there being a sub-data structure associated with each stakeholder of the asset information system and wherein the data for any one asset is distributed among the sub-data structures of the stakeholders for the particular asset, such that no single sub-data structure contains all the data related to a single asset, and wherein one stakeholder cannot directly access a sub-data structure of another stakeholder.

3. The asset management system of claim 2 wherein said asset management system is adapted to receive a request from a user to view information related to an asset, and is adapted, upon receipt of such a request, to obtain the relevant data for the asset from the relevant sub-data structures and to transmit said data to said user to view; whereby, a user does not have direct access to the sub-data structure of any other user.

4. The asset management system of claim 1 wherein said asset management system is configured to notify stakeholders when it is time to conduct routine maintenance of specific assets.

5. The asset management system of claim 1 wherein said asset data further includes one or more testing/calibrating schedules and one or more maintenance schedules for each said asset; wherein said asset management system is configured to notify said stakeholders if scheduled testing/calibrating or scheduled maintenance has been missed.

6. The asset management system of claim 1 wherein said asset management system is configured to:
electronically receive updated asset information regarding the assets from asset manufacturers or their representatives and to electronically distribute said updated information to users; and
provide asset information and aggregated activity information regarding assets to the asset manufacturers, the activity information comprising one or more of the following: status data, testing data, calibration data, repair data, and maintenance data.

7. The asset management system of claim 1 wherein said asset identification information includes one or more of the following: the manufacturer name, asset model, serial number, certification documents, purchase date, and installation date.

8. The asset management system of claim 1 wherein said asset configuration information includes one or more of the following: hardware version and system software version, standards obtained, detection algorithm, related auxiliary hardware, and qualifications and certificates.

9. The asset management system of claim 1 wherein said asset data further includes for each asset: location of the asset and one or more of the following: asset manufacturer, manufacturer make, model and serial number, software version, hardware version, supported auxiliary hardware, installation date, end of life date, and manuals for the asset.

10. The asset management system of claim 1 wherein said asset data further includes for each asset: operational availability, maintenance and/or repair history and/or testing/calibration history.

11. A method of managing physical assets; said method comprising:
storing in a data structure data relating to assets wherein each individual asset is assigned a unique identification code; said data further comprising, for each asset, asset manufacturer information, model name or number, serial number, status history, and service and/or maintenance history;
providing access to said data structure to users, whereby said users can generate status records, calibration records, test records, service records and/or maintenance records for a particular asset and/or change the status of an asset;
aggregating data from said service records, calibration records, and/or test records;
enabling asset manufacturers to (1) provide updated information regarding asset models and/or (2) receive said aggregated data for assets manufactured by said asset manufacturer to enable the asset manufacturer to learn of potential issues relating to their assets.

12. The method of claim 11 wherein said data structure comprises a plurality of distinct and separate sub data-structures, there being a sub-data structure associated with each stakeholder of the asset information system and wherein the data for any one asset is distributed among the sub-data structures of the stakeholders for the particular asset, such that no single sub-data structure contains all the data related to a single asset.

13. The method of claim 12 wherein said method further comprising:
a step of receiving a request from a user to view information related to an asset,
upon receipt of such a request, obtaining the relevant data for the asset from the relevant sub-data structures; and
transmitting said data for said asset to said user to view;
whereby, a user does not have direct access to the sub-data structure of any other user.

14. The method of claim 11 wherein said data further includes one or more testing/calibrating schedules and one or more maintenance schedules for each said asset; wherein said method comprises notifying users of changes in the status of assets and/or missed maintenance or testing; said step of notifying users comprising issuing messages regarding the change of status or displaying icons in an app indicative of the change of status, preferably, wherein said messages are delivered via email or text messaging (such as SMS text messages).

15. The method of claim 11 wherein said service history includes a history of one or more of (1) results of routine testing, (2) calibration results, (3) repairs and/or maintenance, and (4) status.

16. The method of claim 11 wherein said service history includes the date of service and an identification of a natural or juristic person who carried out the service.

17. The method of claim 11 including a step of notifying asset users when said asset manufacturer has provided updated information regarding an asset model.

18. The method of claim 11 wherein said updated information includes one or more of the following: updates to asset documentation, updates to servicing procedures, maintenance notices, software patches, and updated asset software.

19. The method of claim 11 wherein said data structure comprises an asset type harmonization table; said asset type harmonization table providing a concordance between a determined list of types of assets and names for the assets provided by manufacturers and/or asset certifying authorities.

20. An asset management system comprising a processing unit and a non-volatile memory; the memory containing a data structure comprising asset data for a plurality of assets and computer instructions;
wherein said asset data comprises:
i) for each asset, a unique universal identification code and one or more of an asset type, asset identification information, asset configuration information, other unique IDs used by manufacturer, maintainer, operator, or owners, and asset activity history information; and
ii) an asset type for each asset; said asset type being selected from a harmonization table stored in said memory, the harmonization table providing a concordance between a determined list of types of assets and names for the asset provided by manufacturers and/or asset certifying authorities, wherein the asset type for each asset is selected from the asset harmonization table;
wherein said data structure system is configured to:
enable users to add assets to the asset management system;
enable users to enter into said asset management system activity history information data regarding status, testing, calibration, maintenance and/or servicing of said assets; and
enable users to confirm or alter the status of each asset, in particular whether the asset is operable or inoperable;
wherein, when activated, said computer instructions cause the processing unit to:
store in the data structure data the asset data;
provide access to said data structure to users, whereby said users can generate status records, calibration records, test records, service records and/or maintenance records for a particular asset and/or change the status of an asset;
aggregate data from said service records, calibration records, and/or test records;
enable asset manufacturers to (1) provide updated information regarding asset models and/or (2) receive said aggregated data for assets manufactured by said asset manufacturer to enable the asset manufacturer to learn of potential issues relating to their assets.
